(19) United States
(12) Patent Application Publication
(10) Pub. No.: US 2024/0356626 A1
(43) Pub. Date: Oct. 24, 2024

(54) SIGNAL TRANSMITTING METHOD AND APPARATUS

(71) Applicant: FUJITSU LIMITED, Kawasaki-shi Kanagawa (JP)

(72) Inventors: Qinyan JIANG, Beijing (CN); Lei ZHANG, Beijing (CN); Su YI, Beijing (CN); Zhe CHEN, Beijing (CN)

(73) Assignee: FUJITSU LIMITED, Kawasaki-shi Kanagawa (JP)

(21) Appl. No.: 18/672,144

(22) Filed: May 23, 2024

Related U.S. Application Data
(63) Continuation of application No. PCT/CN2021/133742, filed on Nov. 26, 2021.

(51) Int. Cl. H04B 7/155

(52) U.S. Cl. CPC H04B 7/15535

(57) ABSTRACT

An information transmitting apparatus, applicable to a repeater, includes: a receiver configured to receive a first forwarding signal and/or a second forwarding signal; and a transmitter configured to transmit the first forwarding signal at first transmit power and/or a first amplification gain, and/or transmit the second forwarding signal at second transmit power and/or a second amplification gain.

### CROSS-REFERENCE TO RELATED APPLICATION

This application is a continuation application of International Application PCT/CN2021/133742 filed on Nov. 26, 2021, and designated the U.S., the entire contents of which are incorporated herein by reference.

### FIELD

This disclosure relates to the field of communication technologies.

### BACKGROUND

Compared with traditional 2G (second generation mobile communication technology), 3G (third generation mobile communication technology) and 4G (fourth generation mobile communication technology) systems, a 5G (fifth generation mobile communication technology) system is able to provide larger bandwidths and higher data rates, and is able to support more types of terminals and vertical services. For this reason, a frequency band range/operating bandwidth supported by a 5G system is/are obviously higher than those of 2G, 3G and 4G systems, and the 5G system supports higher carrier frequencies. For example, a 5G system may be deployed in a millimeter waveband.

However, the higher a carrier frequency, the more severe a fading experienced by signals during transmission. Therefore, in actual deployment of a 5G system, especially in the millimeter waveband, how to better enhance cell coverage has become an urgent problem to be solved.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

In order to better solve the coverage problem of cellular mobile communication systems in practical deployment, use of a radio frequency (RF) repeater to amplify and forward signals between devices is commonly used means of deployment. RF repeaters are widely used in actual deployment of 2G, 3G and 4G systems, with advantages that it is low in cost, easy in deployment and has no excessive latency. Generally speaking, a traditional RF repeater is a device that amplifies and forwards signals between devices in the RF domain. That is, RF repeaters are non-regenerative type of relay nodes that simply amplify and forward all received signals directly.

A traditional RF repeater has no communication capability. That is, a traditional RF repeater is unable to exchange information with other devices (e.g. a base station/a terminal equipment, etc.). Specifically, in terms of reception, the traditional RF repeater does not support measuring/demodulating/decoding a forwarding signal, nor does it receive signals other than the forwarding signal. In terms of transmission, the traditional RF repeater only amplifies and forwards signals, and does not support generated signals or transmitting signals generated by itself.

Therefore, operation-related configurations (such as amplification gains, and antenna directions, etc.) of the traditional RF repeater are usually manually set or adjusted, and are unable to be adaptively and/or dynamically adjusted. For example, an antenna direction is usually manually set and adjusted during initial installation, so that an antenna at a base station side points towards a direction of an incoming wave of base station, and an antenna at a terminal side point towards an area where enhanced deployment is needed. For another example, an amplification gain is also set and adjusted during initial installation, so as to achieve an expected coverage enhancement effect as much as possible.

It was found by the inventors that using RF repeaters for coverage enhancement is one of feasible solutions to address coverage issues encountered in deployment of 5G systems. However, due to that a traditional RF repeater amplifies and introduces noises and interference while amplifies signals and is lack of communication capabilities, it is unable to adaptively and/or dynamically adjust forwarding power/amplification gain. When such an RF repeater is configured in a 5G system, although it helps enhance signal strength, it is also likely to cause significant interference to other surrounding devices (e.g. base stations or terminal equipment), increases noise and interference levels of the entire system, thereby lowering network throughput.

In addition, compared to 2G, 3G and 4G systems, a 5G system adopts more advanced and complex MIMO (Multiple In Multiple Out) techniques. In the 5G system, especially for higher carrier frequencies, directed antennas become basic components of base stations and terminal equipment. Transmitting and receiving signals based on beamforming is a basic signal transmission method in 5G systems. (Analog) beam directions, and widths, etc., of base stations and terminal equipment may dynamically change due to dynamic changes (i.e. beam switching) of factors, such as positions. However, an antenna of a traditional RF repeater is unable to be dynamically adjusted with respect to directions and has wider beams, and a beam direction and beam width of its transceiving antenna are unable to flexibly match positions of the base stations and terminal equipment and dynamic changes in the beam direction and width of the transceiving antenna. If such an RF repeater is configured in a 5G system, on the one hand, its performance/effect of amplifying/enhancing target signals is not significantly due to that the beam direction and width of its transceiving antenna do not match dynamic changes in beam directions and widths of transceiving antennas of the base stations and terminal equipment, and on the other hand, it may also cause significant interference to other devices within a larger range (e.g. base stations or terminal equipment) due to use of wider transmitting beams.

In order to solve at least one of the above problems, embodiments of this disclosure provide a signal transmitting method and apparatus. Use of the repeater in the solution of this disclosure may better enhance signal coverage and reduce interference to other surrounding devices, thereby improving a transmission efficiency of the whole network.

According to an aspect of the embodiments of this disclosure, there is provided a signal transmitting apparatus, applicable to a repeater, the apparatus including:
a first receiving unit configured to receives a first forwarding signal and/or a second forwarding signal; and
a first transmitting unit configured to transmit the first forwarding signal at first transmit power and/or a first amplification gain, and/or transmit the second forwarding signal at second transmit power and/or a second amplification gain.

According to another aspect of the embodiments of this disclosure, there is provided a signal transmitting apparatus, applicable to a repeater, the apparatus including:
a second transmitting unit configured to transmit a third transmission signal, the third transmission signal including a reference signal, and/or transmit a fourth transmission signal, the fourth transmission signal including a reference signal.

According to a further aspect of the embodiments of this disclosure, there is provided a signal transceiving apparatus, applicable to a third device, the apparatus including:
a transmitting unit configured to transmit first information to a repeater, the first information being used to indicate a first parameter used for the repeater to determine transmit power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal; and/or
a receiving unit configured to receive second information transmitted by the repeater, the second information being used to indicate maximum transmit power and/or a maximum amplification gain of the repeater, and/or being used to indicate transmit power and/or an amplification gain of the repeater, and/or being used to indicate transmit power and/or an amplification gain of a third transmission signal and/or a fourth transmission signal and/or being used to indicate an operational bandwidth of the repeater.

An advantage of the embodiments of this disclosure exists in that by controlling power of the repeater in forwarding signals, signal coverage may be enhanced and interference to other surrounding devices may be reduced, thereby improving a transmission efficiency of the whole network.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of an application scenario of an embodiment of this disclosure;

FIG. 2 is a schematic diagram of a signal transmitting method by a repeater of an embodiment of this disclosure;

FIG. 3 is a schematic diagram of unidirectionally forwarding signals by the repeater of an embodiment of this disclosure;

FIG. 4 is a schematic diagram of bidirectionally forwarding signals by the repeater of an embodiment of this disclosure;

FIGS. 5-7 are exemplary diagrams of forwarding scenarios of the repeater of an embodiment of this disclosure;

FIG. 8 is a schematic diagram of signals between the repeater, the first device and the second device of an embodiment of this disclosure;

FIGS. 9A, 9B and 10-12 are exemplary diagrams of bidirectional forwarding scenarios of the repeater of an embodiment of this disclosure;

FIG. 13 is a schematic diagram of a signal transmitting method by a repeater of an embodiment of this disclosure;

FIG. 14 is a schematic diagram of a signal transmitting method by a repeater of an embodiment of this disclosure;

FIG. 15 is a schematic diagram of a signal transmitting method by a repeater of an embodiment of this disclosure;

FIGS. 16A-16D are exemplary diagrams of forwarded signals by the repeater of an embodiment of this disclosure;

FIGS. 17A and 17B are exemplary diagrams of operational bandwidths of an embodiment of this disclosure;

FIGS. 18A-18C are schematic diagrams of application scenarios of the repeater of an embodiment of this disclosure;

FIG. 19 is a schematic diagram of a change of power of the repeater in amplifying signals of an embodiment of this disclosure;

FIG. 20 is a schematic diagram of the information transmitting apparatus of an embodiment of this disclosure;

FIG. 21 is a schematic diagram of the information transmitting apparatus of an embodiment of this disclosure;

FIG. 22 is a schematic diagram of the repeater of an embodiment of this disclosure;

FIG. 23 is a schematic diagram of a structure of the repeater or device of an embodiment of this disclosure; and

FIGS. 24-30 are schematic diagrams of exchange of information between the repeater, the first device and the second device of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term. A base station may be fixed or mobile.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or a core network device, and may include one or more network devices described above. The term “user side” or “terminal side” or “terminal equipment side” refers to a side of a user or a terminal, which may be a UE, and may include one or more terminal equipment described above.

Without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In the embodiments of this disclosure, signaling includes physical layer signaling and/or higher-layer signaling. The physical layer signaling refers to, for example, DCI. Higher-layer signaling may be, for example, radio resource control (RRC) signaling; for example, it is referred to an RRC message, which includes a master information block (MIB), system information, and a dedicated RRC message; or, it is referred to an as an RRC information element (RRC IE), or an RRC message, or an information domain included in an RRC information element (or an information domain included in an information domain). Higher-layer signaling may also be, for example, medium access control (MAC) signaling, or an MAC control element (MAC CE); however, this disclosure is not limited thereto.

FIG. 1 is schematic diagram of an application scenario of an embodiment of this disclosure. As shown in FIG. 1, for the sake of description, the description shall be given by taking a first device 101, a repeater 102 and a second device 103 as examples; however, this disclosure is not limited thereto. As shown in FIG. 1, the repeater 102 may forward signals between the first device 101 and the second device 103. For example, the repeater 102 may forward signals transmitted by the first device 101 to the second device 103, or the repeater 102 may forward signals transmitted by the second device 103 to the first device 101, or the repeater 102 may forward signals transmitted by the second device 103 to the first device 101 and forward signals transmitted by the first device 101 to the second device 103. In the embodiments of this disclosure, existing traffics or traffics that may be implemented in the future may be performed between the 5G base station and the terminal equipment. For example, such traffics may include but not limited to enhanced mobile broadband (eMBB), massive machine type communication (mMTC), ultra-reliable and low-latency communication (URLLC), and vehicle to everything (V2X) communication, etc.

Various implementations of the embodiments of this disclosure shall be described below with reference to the accompanying drawings. These implementations are illustrative only, and are not intended to limit this disclosure.

### Embodiments of a First Aspect

The embodiments of this disclosure provides a signal transmitting method, which shall be described from a side of a repeater.

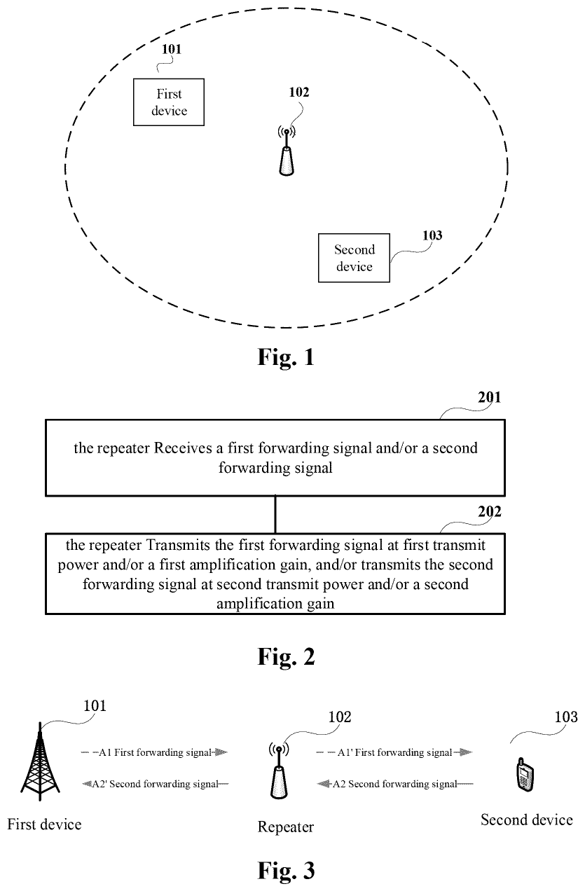

FIG. 2 is a schematic diagram of the signal transmitting method by a repeater of the embodiment of this disclosure. As shown in FIG. 2, the method includes:
201: the repeater receives a first forwarding signal and/or a second forwarding signal; and
202: the repeater transmits the first forwarding signal at first transmit power and/or a first amplification gain, and/or transmits the second forwarding signal at second transmit power and/or a second amplification gain.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In the embodiments of this disclosure, the repeater may also be expressed as an RF repeater, a relay, or an RF relay; or, it may also be expressed as a repeater node, or a relay node; or, it may also be expressed as a smart repeater, a smart relay, a smart repeater node, a smart relay node, etc. A name of the repeater is not limited in this disclosure, and any device that is able to achieve the following functions is included in the scope of the repeater of this disclosure.

In the embodiments of this disclosure, the repeater may be a network device, and/or a terminal equipment, and the repeater has (corresponds to) one or more identifiers used to (uniquely) identify the repeater. When there are multiple identifiers used to identify the repeater, different identifiers have different applications or functions. It should be pointed out that an identifier may have one or more applications or functions, and uses and functions of different identifiers may or may not cross or overlap (however, it is not limited thereto). The above “different uses or functions” refer to that different uses or functions of different identifiers are not completely identical/overlapped.

For example, the one or more identifiers may be used for at least one of the following, one identifier may be used for one or more of the following, and items to which different identifiers correspond cross or overlap or not:
used to uniquely identify the network device within the network device;
used to uniquely identify the terminal equipment within the terminal equipment;
used to identify or manage connection between the repeater and (one/more) network device(s);
used to identify or manage connection between the repeater and (one/more) terminal equipment(s).

For example, the one or more identifiers is/are, for example, an IMSI, or a repeater-specific RNTI or CGI, and is/are preconfigured, or predefined, or configured via signaling; however, the embodiments of this disclosure is not limited thereto.

In the embodiments of this disclosure, the repeater is used to amplify carriers (such as a radiated RF carrier or a conducted RF carrier). For example, the repeater is used to amplify a carrier (first carrier) between the network device and terminal equipment, and/or is used to amplify a carrier (second carrier) between terminal equipment, and/or is used to amplify a carrier (third carrier) between network devices. Wherein, frequency positions and/or frequency ranges of the first/second/third carriers may be identical or different.

Wherein, the first carrier includes, for example, a downlink carrier and/or an uplink carrier (however, this disclosure is not limited thereto). That is, the repeater receives, amplifies and transmits the carriers in a downlink direction (signals from the network device (such as a base stations) to the terminal equipment (or, in other words, a mobile area, or a UE/vehicle)) and/or an uplink direction (signals from the terminal equipment (or, in other words, a mobile area, or a UE/vehicle) to the network device (such as a base stations)). If an operating band(s) of the repeater specifies/specify the downlink direction only or the uplink direction only, the repeater receives, amplifies and transmits the carriers only in the downlink direction or only in the uplink direction accordingly.

Wherein, the second carrier includes, for example, a sidelink carrier (however, this disclosure is not limited thereto). That is, the repeater receives, amplifies and transmits the carrier in a first sidelink direction (signals from a first terminal equipment to a second terminal equipment) and/or a second sidelink direction (signals from the second terminal equipment to the first terminal equipment). If the operating band(s) of the repeater specifies/specify only one of the sidelink directions, the repeater receives, amplifies and transmits the carrier in the sidelink direction accordingly.

Wherein, the third carrier includes, for example, a fronthaul carrier and/or a backhaul carrier (however, this disclosure is not limited thereto). That is, the first device receives, amplifies and transmits the carrier in a fronthaul direction and/or a backhaul direction. If the operating band(s) of the repeater specifies/specify only one of the directions, the repeater receives, amplifies and transmits the carrier in the direction accordingly.

In some cases, the above carriers may be replaced with signals, or, in other words, signals transmitted on the above carrier. The first forwarding signal comes from the first device and is transmitted to the second device, and the second forwarding signal comes from the second device and is transmitted to the first device, that is, in 201, the repeater receives the first forwarding signal transmitted by the first device and/or the second forwarding signal transmitted by the second device; and in 202, the repeater forwards the first forwarding signal to the second device and/or forwards the second forwarding signal to the first device.

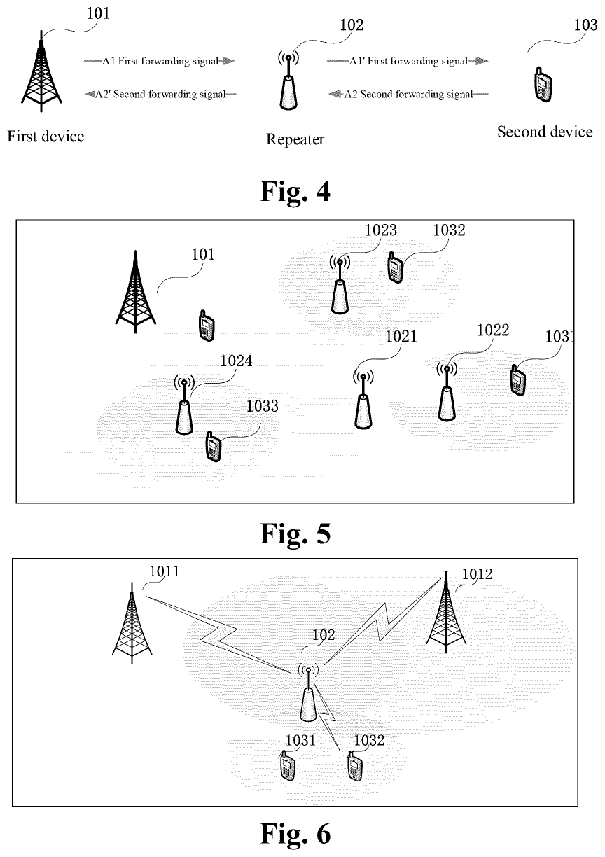

That is, the repeater is used to receive, amplify and forward signals between the first device and the second device, wherein the repeater may unidirectionally amplify and forward the signals between the first device and the second device, and may also bidirectionally amplify and forward the signals between the first device and the second device, which shall be described below with reference to FIGS. 3 and 4.

FIG. 3 is a schematic diagram of unidirectionally forwarding signals by the repeater. As shown in FIG. 3. The repeater 102 may forward (or transmit) a first forwarding signal (also referred to as a first transmission signal) transmitted by the first device 101 to the second device 103, or the repeater 102 may forward a second forwarding signal (also referred to as a second transmission signal) transmitted by the second device 103 to the first device 101. For example, the first device is a network device, the second device is a terminal equipment, and the first forwarding signal transmitted by the first device is a downlink signal, including, for example, an SSB (including a PSS, an SSS, a PBCH, and a DMS of a PBCH), a CSI-RS, a PDCCH, a PDSCH, a DM-RS, a PT-RS, and a PRS, etc.; the second forwarding signal transmitted by the second device is an uplink signal, including, for example, a PRACH, a PUCCH, a PUSCH, and an SRS, etc., that is, the repeater is used to amplify and forward the downlink signal and/or the uplink signal. For another example, both the first device and the second device are terminal equipment, the first forwarding signal transmitted by the first device is referred to as, for example, a first sidelink signal, and the second forwarding signal transmitted by the second device is referred to as, for example, a second sidelink signal, the first sidelink signal and the second sidelink signal respectively including, for example, an S-SSB (an S-PSS, an S-SSS, a PSBCH, and a DMRS of a PSBCH), a PSSCH, a PSCCH, a PSFCH, a DMRS, a PT-RS, a CSI-RS, and an SRS, etc. For a further example, the first device is a first network device (such as a base station or an IAB node), the second device is a second network device (such as a base station or an IAB node), the signal transmitted by the first device is, for example, a fronthaul signal or a downlink signal, and the signal transmitted by the second device is, for example, a backhaul signal or an uplink signal, the signal transmitted by the first network device and the signal transmitted by the second network device respectively including, for example, an inter-node message, an SSB, a CSI-RS, a PDCCH, a PDSCH, a PRS, a PRACH, a PUCCH, a PUSCH, and an SRS, etc.; however, this disclosure is not limited thereto. Wherein, when the first network device and the second network device are IAB nodes and the first network device is a parent node of the second network device, in some cases, the first network device may also be referred to as an IAB-DU of the first network device, the signal from the first network device to the second network device may also be referred to as a signal (such as an SSB, a CSI-RS, a PDCCH, a PDSCH, and a PRS, etc.; however, this disclosure is not limited thereto) from the IAB-DU of the first network device to an IAB-MT of the second network device or a downlink signal, and the signal from the second network device to the first network device may also be referred to as a signal (a PRACH, a PUCCH, a PUSCH, and an SRS, etc.; however, this disclosure is not limited thereto) from the IAB-MT of the second network device to the IAB-DU of the first network device or an uplink signal.

FIG. 4 is a schematic diagram of bidirectionally forwarding signals by the repeater. As shown in FIG. 4, the repeater 102 may forward the first forwarding signal (also referred to as a first transmitting signal) transmitted by the first device 101 to the second device 103, and the repeater 102 may forward the second forwarding signal (also referred to as a second transmitting signal) transmitted by the second device 103 to the first device 101. For example, the first device is a network device, and the second device is a terminal equipment, or both the first device and the second device are terminal equipment, or both the first device and the second device are network devices. Reference may be made to the unidirectional forwarding in FIG. 3 for specific signal types of the first forwarding signal and the second forwarding signal, which shall not be repeated herein any further.

In the embodiments of this disclosure, the network device may support (serve for) one or more cells, which may be referred to as served cells of the network device. In some cases, the network device may also be referred to as (replaced with) a cell or a serving cell, etc., which shall not be repeated herein any further. For example, the first device is a network device, the second device is a terminal equipment, and a cell served by the first device is referred to as a first cell, and it may also be said that the repeater is used to amplify a downlink signal and/or an uplink signal of the first cell. The first cell is or is not a serving cell of the repeater and/or the terminal equipment. In the embodiments of this disclosure, the repeater, the first device and the second device are at different geographical positions, and are not connected to each other by lines (such as optical cables). That is, the repeater, the first device and the second device transmit/receive signals to/from each other via air interfaces.

In the embodiments of this disclosure, the number of repeaters used between the first device and the second device may be one or more, that is, the signal between the first device and the second device may be amplified once or multiple times. Wherein, each of the multiple repeaters may amplify and forward the signal in the same manner, and following description shall be given by taking only one repeater as an example. It should be noted that when there are multiple repeaters between the first device and the second device, a signal received by one of the repeaters may be transmitted from the first device, or may be amplified by other repeaters. FIG. 5 is a schematic diagram of a scenario of forwarding by the repeater. As shown in FIG. 5, there are two repeaters 1021 and 1022 between the first device 101 and the second device 1031, there is a repeater 1023 between the first device 101 and the second device 1032, and there is a repeater 1024 between the first device 101 and the second device 1033.

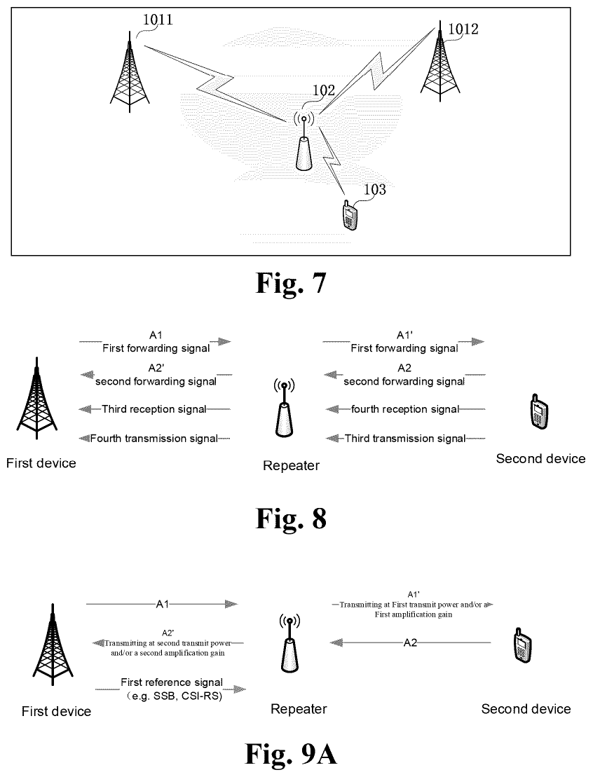

In the embodiments of this disclosure, a repeater may also serve for one or more first devices or second devices, and operating frequencies of different first devices or second devices are identical or different. FIGS. 6 and 7 are schematic diagrams of scenarios of forwarding by the repeater. As shown in FIG. 6, the repeater 102 serves for two network devices 1011 and 1012 of different operating frequencies. And furthermore, operating frequencies of the two terminal equipment 1031 and 1032 are identical or different. As shown in FIG. 7, the repeater 102 serves for two network devices 1011 and 1012 of identical operating frequencies.

In the embodiments of this disclosure, signals exchanged between the repeater and other devices include forwarding signals and communication signals, wherein signals between the first device and second device (or signals generated by the first device and/or signals generated by the second device) that may be forwarded by the repeater are referred to as forwarding signals, and the repeater receives, amplifies and transmits the forwarding signals in an RF domain. Generally, the repeater performs such signal processing as frequency conversion, filtering, and amplification, etc., on the received forwarding signals and then transmits them. In addition, the repeater may also receive communication signals (also referred to as reception communication signals), and the repeater needs to measure and/or demodulate and/or decode the communication signals; or, the repeater may also transmit communication signals (also referred to as transmission communication signals or generation signals). In order to transmit the communication signals, the repeater needs to perform sequence generation and/or encoding and/or modulation, etc. The forwarding signals and communication signals transmitted by the repeater may be independently transmitted or may be combined into one signal and transmitted. For example, one of modes based on time division (TD), frequency division (FD), code division (CD) and spatial division, etc. or any combination thereof may be used for combination, and this disclosure is not limited thereto.

In some embodiments, if a signal belongs to a forwarding signal, receiving the signal by the repeater refers to receiving the signal in the RF domain (i.e. the repeater does not measure and/or demodulate and/or decode the signal), and the repeater transmits the signal in the RF domain (i.e. the repeater does not perform sequence generation and/or encoding and/or modulation for the purpose of transmitting the signal). If a signal belongs to a communication signal, receiving the signal by the repeater (assuming that the signal belongs to a reception communication signal) includes that the repeater measures and/or demodulates and/or decodes the signal, and the repeater transmits the signal (assuming that the signal belongs to a transmission communication signal). In order to transmit the signal, sequence generation and/or encoding and/or modulation is/are needed.

In some embodiments, the communication signal includes a communication signal between the repeater and the first device, and/or a communication signal between the repeater and the second device. Furthermore, the communication signal between the repeater and the first device includes a signal transmitted by the first device to the repeater (such as being referred to as a first downlink communication signal, or a first reception communication signal) and/or a signal transmitted by the repeater to the first device (such as being referred to as a first uplink communication signal, or a first transmission communication signal, or a first generation signal, or an uplink generation signal). Likewise, the communication signal between the repeater and the second device includes a signal transmitted by the repeater to the second device (such as being referred to as a second downlink communication signal, or a second transmission communication signal, or a second transmission communication signal, or a second generation signal, or a downlink generation signal) and/or a signal transmitted by the second device to the repeater (such as being referred to as a second uplink communication signal, or a second reception communication signal). In some embodiments, the communication signal includes a communication signal between the repeater and the third device. And furthermore, the communication signal between the repeater and the third device includes a signal transmitted by the third device to the repeater (such as a third downlink communication signal, or a third reception communication signal, which may carry first information described later) and/or a signal transmitted by the repeater to the third device (such as being referred to as a third uplink communication signal, or a third transmission communication signal, or a third generation signal, or a second uplink generation signal, which may carry second information described later).

FIG. 8 is a schematic diagram of exchanging signals between the first device, the second device and the repeater. For example, the signals between the first device and the second device forwarded by the repeater are referred to as forwarding signals (such as first forwarding signals A1, A1′ and second forwarding signals A2, A2′), and the repeater may perform signal processing such as receive, filter, amplify and transmit the forwarding signals, but it does not decode and/or demodulate and/or measure the forwarding signals. Signals between the first device/the second device and the repeater other than the above forwarding signals are referred to as communication signals, such as a third reception signal, a fourth reception signal, a third transmission signal and a fourth transmission signal shown in FIG. 8, and the repeater needs to decode and/or demodulate and/or measure the third reception signal and/or the fourth reception signal, and needs to encode and/or modulate the third transmission signal and/or the fourth transmission signal, or needs to generate the third transmission signal and/or the fourth transmission signal (the generation is based or not based on the third reception signal and/or fourth reception signal), etc., wherein the third reception signal includes, for example, a first reference signal described later, and the fourth reception signal includes for example, a second reference signal described later, etc.

It should be noted that not all signals needing to be forwarded are referred to as forwarding signals, and the above forwarding signals are only for forwarding signals that the repeater will not decode and/or demodulate and/or measure. For example, when the repeater receives the third reception signal (such as a first reference signal), it may also forward the third reception signal to the second device (i.e. the third transmission signal) (or not forward). However, as the repeater performs such operations as measurement on the third reception signal, the third reception signal is also referred to as a communication signal.

In the embodiments of this disclosure, the repeater needs to determine (calculate) transmit power for transmitting forwarding signals and/or communication signals, which shall be described below in detail.

Following description shall be given by taking signals between the network device and the terminal equipment forwarded via the repeater (i.e. the first device is the network device, and the second device is the terminal equipment) as an example, and a mode for processing signals between terminal equipment and signals between network devices forwarded via the repeater is similar thereto.

In some embodiments, the first forwarding signal comes from the first device and is transmitted to the second device, and the second forwarding signal comes from the second device and is transmitted to the first device. In 201, receiving by the repeater the first forwarding signal transmitted by the first device may be directly receiving the first forwarding signal transmitted by the first device, and may also be receiving the first forwarding signal transmitted by the first device forwarded via other repeaters; and receiving by the repeater the second forwarding signal transmitted by the second device may be directly receiving the second forwarding signal transmitted by the second device, and may also be receiving the second forwarding signal transmitted by the second device forwarded via other repeaters. In 202, the first forwarding signal is forwarded to the second device at the first transmit power and/or the first amplification gain and/or the second forwarding signal is forwarded to the first device at the second transmit power and/or the second amplification gain. The information carried by the forwarding signals is identical, but the transmit power is amplified by the repeater, that is, the repeater needs to amplify the received first forwarding signal and/or second forwarding signal, and forward the first forwarding signal and/or the second forwarding signal.

As described above, in the embodiments of this disclosure, the repeater supports unidirectional forwarding and/or bidirectional forwarding. For example, when only unidirectional forwarding is supported, the repeater only needs to determine unidirectional transmit power and/or a unidirectional amplification gain; and when bidirectional forwarding is supported, the repeater needs to determine bidirectional transmit power and/or amplification gain. For the convenience of description, the transmit power and/or amplification gain is/are respectively referred to as first transmit power and/or a first amplification gain for forwarding the first forwarding signal and second transmit power and/or a second amplification gain for forwarding the second forwarding signal. Wherein, the first transmit power and the first amplification gain are respectively referred to as, for example, terminal equipment side transmit power and a terminal equipment side amplification gain, or are respectively referred to as downlink transmit power and a downlink amplification gain; and correspondingly, the second transmit power and the second amplification gain are respectively referred to as network device side transmit power and a network side amplification gain, or are respectively referred to as uplink transmit power and an uplink amplification gain.

Transmit power and/or an amplification gain described later include(s) first transmit power and/or a first amplification gain, and/or, second transmit power and/or a second amplification gain, wherein methods for determining the first transmit power and the second transmit power are identical or different, and/or methods for determining the first amplification gain and/or the second amplification gain are identical or different, values of the first amplification gain and the second amplification gain are identical or different, and values of the first transmit power and the second transmit power are identical or different, which shall be described later.

In some embodiments, the repeater determines (calculates, determination and calculation are hereinafter interchangeable) the first transmit power and/or first amplification gain based on at least one of the following items, and/or determines the second transmit power and/or second amplification gain based on at least one of the following items: a reference signal, a bandwidth, a subcarrier spacing, a target transmitting device, maximum transmit power, a maximum transmission gain, a pathloss and/or a coupling loss. The at least one item used to determine (or corresponding to) the first transmit power and/or the first amplification gain is identical to or different from the at least one item used to determine (or corresponding to) the second transmit power and/or the second amplification gain, wherein the at least one item may also be referred to as at least one factor, and the at least one factor used to determine (or corresponding to) the first transmit power and/or the first amplification gain is identical to or different from the at least one factor used to determine (or corresponding to) the second transmit power and/or the second amplification gain, wherein at least one factor is different includes that types of the factors are different, numbers of the factors are different, or types and numbers of the factors are identical but configurations of the factors are different or values of the factors are different. Or, that at least one item is different includes that only the first transmit power and/or the first amplification gain or only the second transmit power and/or the second amplification gain is/are determined according to one of the items, and the first transmit power and/or first amplification gain and the second transmit power and/or the second amplification gain is/are determined according to one of the items, but are configured separately. That at least one item is identical includes that the first transmit power and/or the first amplification gain and the second transmit power and/or the second amplification gain are determined according to one of the items, and configuration of the item is shared/common.

Following is detailed explanations.

On the one hand, the repeater determines the transmit power and/or the amplification gains based on reference signals, the reference signals including an SSB, and/or an S-SSB, and/or a CSI-RS, and/or an SRS; however, this disclosure is not limited thereto. Distinguished from a transmitter end of the reference signals, the reference signals include a first reference signal transmitted by the first device or the third device and/or a second reference signal transmitted by the second device and/or a third reference signal transmitted by a fourth device, the first device and the third device being identical or different. The first reference signal or the second reference signal or the third reference signal may be any one of an SSB, and/or an S-SSB, and/or a CSI-RS, and/or an SRS, depending on a type of transmitter. The above reference signals may be transmitted periodically or aperiodically.

In some embodiments, determining the transmit power and/or amplification gain by the repeater according to the first reference signal/second reference signal includes: determining the first transmit power and/or the first amplification gain and/or determining the second transmit power and/or the second amplification gain by the repeater according to the first reference signal/second reference signal. For example, according to the first reference signal transmitted by the first device or the third device, the repeater determines power and/or an amplification gain (first transmit power and/or a first amplification gain) of the first forwarding signal transmitted to the second device, and/or, according to the first reference signal transmitted by the first device or the third device, the repeater determines power and/or an amplification gain (second transmit power and/or a second amplification gain) of the second forwarding signal transmitted to the first device, and/or, according to the second reference signal transmitted by the second device, the repeater determines the power and/or the amplification gain (the first transmit power and/or the first amplification gain) of the first forwarding signal transmitted to the second device, and/or, according to the second reference signal transmitted by the second device, the repeater determines the power and/or the amplification gain (the second transmit power and/or the second amplification gain) of the second forwarding signal transmitted to the first device.

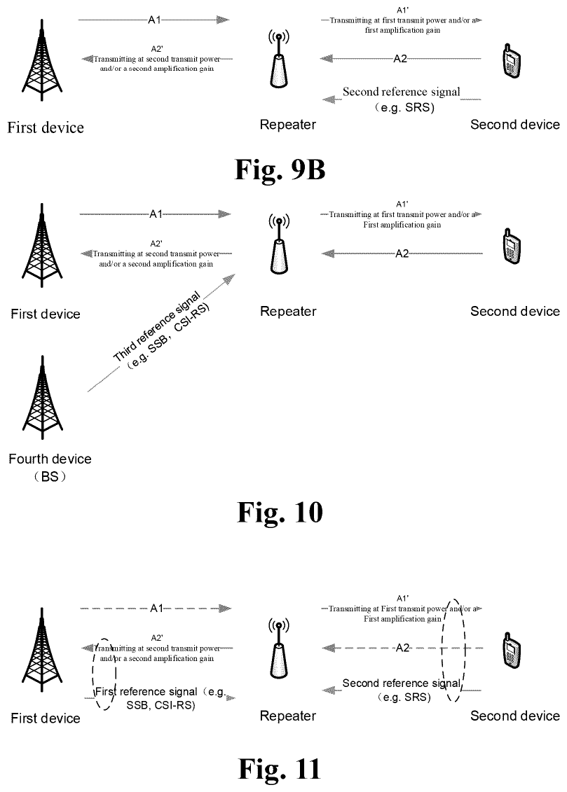

FIGS. 9A and 9B are schematic diagrams of scenarios of bidirectional forwarding by the repeater. As shown in FIG. 9A, the repeater determines the first transmit power and/or the first amplification gain and the second transmit power and/or the second amplification gain according to the first reference signal transmitted by the first device. As shown in FIG. 9B, the repeater determines the first transmit power and/or the first amplification gain and the second transmit power and/or the second amplification gain according to the second reference signal transmitted by the second device.

In some embodiments, determining the transmit power and/or the amplification gain by the repeater according to a third reference signal includes: performing measurement based on the third reference signal, and determining the transmit power and/or the amplification gain, by the repeater, and the fourth device may be a network device and/or a terminal equipment. FIG. 10 is a schematic diagram of a scenario of bidirectional forwarding by the repeater. As shown in FIG. 10, the fourth device is a network device, the third reference signal is, for example, an SSB, or a CSI-RS, and the repeater may perform measurement based on the third reference signal, and determine the first transmit power and/or the first amplification gain and the second transmit power and/or the second amplification gain.

In some embodiments, the reference signal used to determine the first transmit power and/or the first amplification gain is identical to or different from the reference signal used to determine the second transmit power and/or the second amplification gain, wherein that the reference signals are different includes that transmitter ends of the reference signals are different, and/or types of the reference signals are different, and/or indices of the reference signals are different.

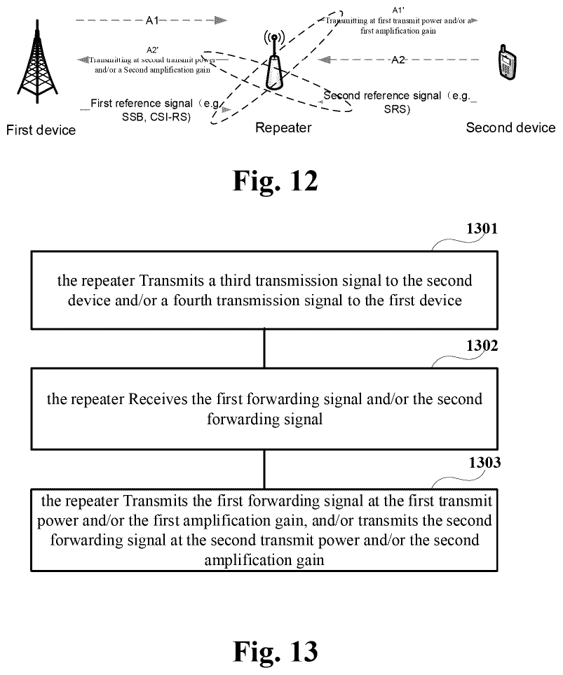

When the transmitter ends of the reference signals are different, for example, FIGS. 11 and 12 are schematic diagrams of scenarios of bidirectional forwarding by the repeater. As shown in FIG. 11, what is used to determine the first transmit power and/or the first amplification gain is the second reference signal, and what is used to determine the second transmit power and/or the second amplification gain is the first reference signal. As shown in FIG. 12, what is used to determine the first transmit power and/or the first amplification gain is the first reference signal, and what is used to determine the second transmit power and/or the second amplification gain is the second reference signal.

When the transmitter ends of the reference signals are identical but the types of the reference signals are different and/or the indices of the reference signals (indices or numbers of the reference signals in the same type of reference signals) are different, for example, what is used to determine the first transmit power and/or the first amplification gain is an SSB, and what is used to determine the second transmit power and/or the second amplification gain is a CSI-RS, or, a reference signal used to determine the first transmit power and/or the first amplification gain is an SSB with a reference signal index 1, and a reference signal used to determine the second transmit power and/or the second amplification gain is an SSB with a reference signal index 2, which shall not be enumerated herein any further.

In the embodiments of this disclosure, the reference signals are used for determining a pathloss and/or a coupling loss by the repeater, and/or used for performing measurement by the repeater. For example, the first/second reference signal is/are used for determining the pathloss and/or the coupling loss by the repeater, or the third reference signal is used for performing measurement by the repeater, or the first/second reference signal is/are used for performing measurement and determining the pathloss and/or the coupling loss, or the first/second reference signal is/are used for performing measurement by the repeater. Or, in other words, determining the transmit power and/or amplification gain by the repeater according to the reference signals includes: determining pathlosses and/or coupling losses to which the reference signals correspond, and/or performing measurement based on the reference signals, by the repeater. For example, the repeater determines pathloss(es) and/or coupling loss(es) to which the first/second reference signal correspond(s), or performs measurement based on the third reference signal, or performs measurement based on the first/second reference signal, and determines the pathloss(es) and/or coupling loss(es) to which the first/second reference signal correspond(s), or performs measurement based on the first/second reference signal, wherein a method for determining the pathloss(es) and a method for determining the coupling loss(es) are identical or different, and following description shall be given by taking that the methods are identical as an example.

For example, following formula (1) may be used to determine the pathloss(es) and/or the coupling loss(es) to which the reference signals correspond:

$$PL / CL = {P}_{tx , tr}^{RS} - {P}_{rx , sr}^{RS} ; \qquad Formula ( 1 )$$

where, P_{tx,tr}^{RS} (dBm), for example, denotes the transmit power of the reference signals, a value of which being, for example, predefined, or indicated/notified via signaling. It should be pointed out that P_{rx,sr}^{RS} (dBm) here is used to determine the above losses, and is not necessarily actual transmit power, that is, it may be greater than, or equal to, or less than the actual transmit power.
where, P_{tx,tr}^{RS}, for example, denotes received power of the reference signals, such as RSRP (dBm). The value of this parameter is, for example, a measured value (or a filtered value) of layer 1 (physical layer) or a measured value (or a filtered value) of a higher layer (such as layer 3, RRC layer). Assuming that the parameter is RSRP, for example, the parameter is L1-RSRP or L3-RSRP (higher layer filtered value). Wherein, if the reference signal is an SSB, L1-RSRP is, for example, also referred to as SS-RSRP, and if the reference signal is a CSI-RS, L1-RSRP is, for example, also referred to as CSI-RSRP.

For example, performing measurement based on the reference signals includes measuring RSRP and/or RSRQ and/or SINR and/or RSSI, and reference may be made to existing measurement methods, which are not limited in this disclosure.

It should be noted that reference may be made to an existing terminal equipment for implementation of determining the pathlosses and/or coupling losses to which the reference signals correspond by the repeater or determining the transmit power and/or amplification gain based on measurement of the reference signals by the repeater, and the embodiments of this disclosure is not limited thereto. For example, the transmit power is determined based on the determined pathlosses and/or coupling losses and target received power, which shall not be repeated herein any further.

On the one hand, the repeater determines the transmit power and/or amplification gain according to a bandwidth and/or a subcarrier spacing. The bandwidth includes a pass band bandwidth and/or a carrier bandwidth and/or a BWP bandwidth and/or a signal bandwidth; and the subcarrier spacing includes a carrier SCS and/or a BWP SCS and/or a signal SCS. Wherein, the bandwidth is, for example, denoted by the number of sets of subcarriers (such as RBs) or the number of subcarriers, or the number of unit bandwidths or absolute values (such as kHz, MHz, etc.). Here, the unit bandwidths are based on the absolute values, such as 30 kHz. Generally, when the bandwidth is denoted by the number of sets of subcarriers (such as RBs) or the number of subcarriers, it is based on an SCS (subcarrier spacing), the SCS being predefined, or being configured by signaling.

In some embodiments, the determining the transmit power and/or amplification gain by the repeater according to a bandwidth and/or a subcarrier spacing includes determining power and/or an amplification gain of a signal transmitted on the subcarrier and signal power and/or an amplification gain on the entire signal bandwidth according to the bandwidth and/or the subcarrier spacing.

In some embodiments, the bandwidth and/or the subcarrier spacing used to determine the first transmit power and/or the first amplification gain and the bandwidth and/or the subcarrier spacing used to determine the second transmit power and/or the second amplification gain are identical or different.

On the one hand, the determining the transmit power and/or the amplification gain by the repeater according to target transmitting devices includes determining the transmit power and/or the amplification gain according to the number of target transmitting devices and/or operating frequency bands of the target transmitting devices and/or bandwidths. The target transmitting devices are devices with signals needing to be forwarded via the repeater, and the target transmitting devices' number/operating frequency bands/bandwidths affect the signal bandwidths. Therefore, the signal power and/or amplification gains on the entire signal bandwidth may be determined according to the target transmitting devices' number/operating frequency bands/bandwidths.

On the one hand, the determining the transmit power and/or the amplification gain by the repeater according to the maximum transmit power and/or the maximum transmission gain includes taking the maximum transmit power and/or the maximum transmission gain into account in determination, so that the determined transmit power and/or amplification gain do(es) not exceed the maximum transmit power and/or the maximum transmission gain.

In some embodiments, the maximum transmit power (first maximum transmit power) and/or the maximum amplification gain (first maximum amplification gain) used to determine the first transmit power and/or the first amplification gain is/are identical to or different from the maximum transmit power (second maximum transmit power) and/or the maximum transmission gain (second maximum amplification gain) used to determine the second transmit power and/or the second amplification gain. When the determined first transmit power and/or the first amplification gain exceed(s) the first maximum transmit power and/or the first maximum transmission gain, the first transmit power and/or the first amplification gain need (d) to be adjusted, so that it/they do(es) not exceed the first maximum transmit power and/or the first maximum transmission gain, and when the determined second transmit power and/or the second amplification gain exceed(s) the second maximum transmit power and/or the second maximum transmission gain, the second transmit power and/or the second amplification gain need (d) to be adjusted, so that it/they do(es) not exceed the second maximum transmit power and/or the second maximum transmission gain.

In some embodiments, the maximum transmit power and/or the maximum amplification gain is/are preconfigured and/or configured via signaling. Preconfiguring refers to that the repeater configures by itself when, for example, a certain requirement (such as a value or range specified in a protocol) is satisfied, and configuring via signaling refers to, for example, that the repeater configures according to received signaling, the signaling being used to indicate/configure the maximum transmit power and/or maximum amplification gain of the repeater. When the repeater supports bidirectional forwarding, the first maximum transmit power and/or the first maximum transmission gain and the second maximum transmit power and/or the second maximum transmission gain may respectively be predefined, and/or preconfigured, and/or configured via signaling.

On the one hand, the repeater determines the transmit power and/or the amplification gain according to the pathloss and/or the coupling loss, such as determining the transmit power and/or the amplification gain according to the pathloss and/or the coupling loss and target received power, wherein the pathloss and/or the coupling loss may be, for example, determined based on the first reference signal and/or second reference signal described above or a third transmission signal and/or a fourth transmission signal described later, which shall not be repeated herein any further.

For example, the repeater determines the first transmit power and/or the first amplification gain, the second transmit power and/or the second amplification gain according to a first path (or coupling) loss, and/or a second path (or coupling) loss, and/or a third path (or coupling) loss, and/or a fourth path (or coupling) loss. The first path (or coupling) loss refers to a path (or coupling) loss between the first device and the repeater, the second path (or coupling) loss refers to a path (or coupling) loss between the second device and the repeater, the third path (or coupling) loss refers to, for example, a path (or coupling) loss between the third device and the repeater, and the fourth path (or coupling) loss refers to, for example, a path (or coupling) loss between the first device and the third device.

The first path (or coupling) loss is, for example, measured by the repeater based on the first reference signal transmitted by the first device. The second path (or coupling) loss is, for example, measured by the repeater based on the second reference signal transmitted by the second device, or, is obtained by the second device based on measurement of the first reference signal transmitted by the first device (forwarded by the repeater), or, is obtained based on measurement of the fourth reference signal generated and transmitted by the repeater to the second device (the second device transmits a measurement result to the first device and/or the third device and/or the repeater). The third path (or coupling) loss is, for example, obtained by the repeater based on measurement of the first reference signal transmitted by the third device. And the fourth path (or coupling) loss is, for example, obtained by the second device based on measurement of the first reference signal transmitted by the first device (forwarded by the repeater) (the second device transmits a measurement result to the first device and/or the third device and/or the repeater); however, it is not limited thereto.

For example, the repeater determines the second transmit power Ptx, sr and/or the second amplification gain Gain according to the fourth pathloss by using the following formulae (2)-(3) (influences of such factors as a bandwidth/SCS, etc., are omitted here):

$$Ptx , sr = Prx , sr + first pathloss , or \\ Ptx , sr = min ( P max , Prx , sr + first pathloss ) , \qquad formula ( 2 )$$

$$Gain = first pathloss , or Gain = min ( G max , first pathloss ) ; \qquad formula ( 3 )$$

where, Pmax, Prx, sr and Gmax denote the maximum transmit power and the maximum amplification gain, and Prx, sr denotes the target received power. Implementations of the third transmission signal and the fourth transmission signal shall be described later.

Implementations of determining the transmit power and/or the amplification gain in the above aspects may be implemented separately or in a combined manner, and the embodiments of this disclosure is not limited thereto.

In some embodiments, for further power control, the repeater may also transmit a third transmission signal to the second device, and/or transmit a fourth transmission signal to the first device, and/or receive first information transmitted by the third device, and/or transmit second information to the third device, which shall be described below respectively.

FIG. 13 is a schematic diagram of the signal transmitting method of the embodiment of this disclosure. As shown in FIG. 13, the method includes:
1301: the repeater transmits a third transmission signal to the second device and/or a fourth transmission signal to the first device;
1302: the repeater receives the first forwarding signal and/or the second forwarding signal; and
1303: the repeater transmits the first forwarding signal at the first transmit power and/or the first amplification gain, and/or transmits the second forwarding signal at the second transmit power and/or the second amplification gain.

In some embodiments, the third transmission signal is used by the second device for determining the pathloss and/or coupling loss, and/or for performing measurement by the second device; and the fourth transmission signal is used by the first device for determining the pathloss and/or coupling loss, and/or for performing measurement by the first device, the measurement referring to RSRP, and/or RSRQ, and/or an SINR, and/or an RSSI, and methods for measuring and determining the pathloss and/or coupling loss being as described above, which shall not be repeated herein any further. For example, the third transmission signal or fourth transmission signal may be generated by the repeater, or the third transmission signal may be generated by the first device and transmitted to the repeater, and the fourth transmission signal may be generated by the second device and transmitted to the repeater; however, this disclosure is not limited thereto. Transmit power and/or an amplification gain(s) of the third transmission signal and/or the fourth transmission signal may be determined according to the first information described later, or may be determined in a method similar to that for determining the first forwarding signal and/or the second forwarding signal; however, the embodiments of this disclosure is not limited thereto. Optionally, the transmit power and/or the amplification gain(s) of the third transmission signal and/or the fourth transmission signal may also be included in the second information described later and transmitted to the third device. Refer may be made to the following description for details, which shall not be repeated herein any further.

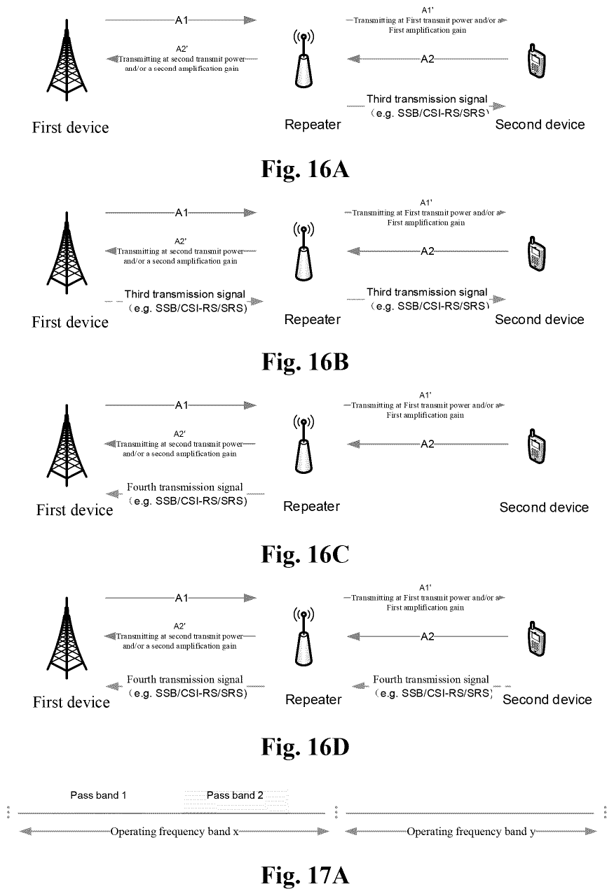

FIGS. 16A-16D are schematic diagrams of scenarios of forwarded signal by the repeater. As shown in FIGS. 16A and 16C, the third transmission signal or the fourth transmission signal is/are generated by the repeater and transmitted to the second device or first device at certain power. As shown in FIG. 16B, the third transmission signal is generated by the first device and transmitted to the repeater, and then transmitted by the repeater to the second device. As shown in FIG. 16D, the fourth transmission signal is generated by the second device and transmitted to the repeater, and then transmitted by the repeater to the first device.

In some embodiments, the third transmission signal and/or the fourth transmission signal may include reference signals, such as an SSB, a CSI-RS, and an SRS, etc., and this disclosure is not limited thereto.

In some embodiments, the second device transmits/reports a result of determination/measurement based on the third transmission signal to the repeater, and/or the first device, and/or the third device, or, the first device transmits/reports a result of determination/measurement based on the fourth transmission signal to the repeater, and/or the second device, and/or the third device.

For example, the repeater receives the measurement results based on the third transmission signal and/or the fourth transmission signal from the second device or the first device, and in 1303, the repeater determines the transmit power and/or the amplification gain of the first forwarding signal transmitted to the second device and/or determines the transmit power and/or the amplification gain of the second forwarding signal transmitted to the first device directly based on the measurement results. For example, the repeater determines the transmit power and/or the amplification gain of the first forwarding signal transmitted to the second device and/or determines the transmit power and/or the amplification gain of the second forwarding signal transmitted to the first device based on a pathloss and/or a coupling loss determined according to the measurement results, and specific implementations thereof are as described above, which shall not be repeated herein any further.

For example, the repeater determines the first transmit power and/or the first amplification gain of the first forwarding signal transmitted to the second device and/or determines the second transmit power and/or the second amplification gain of the second forwarding signal transmitted to the first device not directly based on the measurement results. For example, when the repeater does not receive the measurement results based on the third transmission signal and/or the fourth transmission signal of the second device or the first device, or when the second device reports the measurement results to the first device or the third device, and/or when the first device reports the measurement results to the second device or the third device, the device (such as the third device) receiving the measurement results may transmit the first information (described later) to the repeater based on the measurement results, and the repeater determines the first transmit power and/or the first amplification gain of the first forwarding signal transmitted to the second device and/or determines the second transmit power and/or the second amplification gain of the second forwarding signal transmitted to the first device based on the first information.

It should be noted that in 1303, the repeater may determine the first transmit power and/or the first amplification gain of the first forwarding signal transmitted to the second device and/or determine the second transmit power and/or the second amplification gain of the second forwarding signal transmitted to the first device only based on measurement results or based on the first information, and may also determine the first transmit power and/or the first amplification gain of the first forwarding signal transmitted to the second device and/or determine the second transmit power and/or the second amplification gain of the second forwarding signal transmitted to the first device in combination with the implementations described in the above aspects, and the embodiments of this disclosure is not limited thereto.

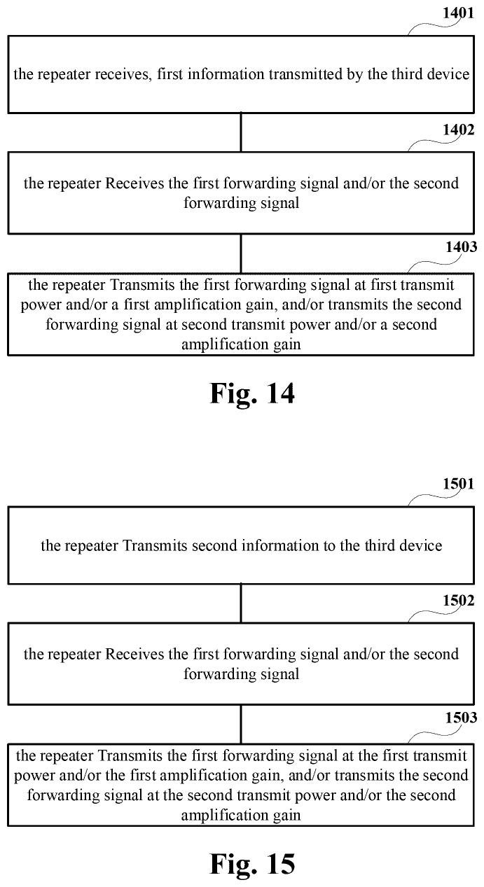

FIG. 14 is a schematic diagram of the signal transmitting method of the embodiment of this disclosure. As shown in FIG. 14, the method includes:
1401: the repeater receives, first information transmitted by the third device, the first information being used to indicate a first parameter used by the repeater to determine transmit power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal;
1402: the repeater receives the first forwarding signal and/or the second forwarding signal; and
1403: the repeater transmits the first forwarding signal at first transmit power and/or a first amplification gain, and/or transmits the second forwarding signal at second transmit power and/or a second amplification gain.

In the following description, the “parameters” may also replaceably express the term “configuration”. The above first information may be directly configured by the third device for the repeater, or may be indicated by the third device to the repeater based on the measurement results reported by the first device or the second device, and the embodiments of this disclosure is not limited thereto. The above first information may be included in side control information and transmitted, the side control information including, for example, a signal/information for configuring/indicating operating parameters of the repeater, and/or signal/information for establishing connection between the repeater and a network device and/or a terminal equipment. However, this disclosure is not limited thereto, and the side control information may be deemed as a communication signal.

In some embodiments, the first parameter includes the transmit power and/or an amplification gain of the repeater, or maximum transmit power and/or a maximum amplification gain of the repeater. The repeater may determine the first transmit power and/or the first amplification gain and/or the second transmit power and/or the second amplification gain according to the first parameter, that is, in 1403, the repeater may forward the first forwarding signal according to the first transmit power and/or the first amplification gain determined by the first parameter and/or forward the second forwarding signal according to the second transmit power and/or the second amplification gain determined by the first parameter. When the first parameter is the transmit power and/or the amplification gain of the repeater, the repeater may directly determine the transmit power and/or the amplification gain; and when the first parameter is maximum transmit power and/or a maximum amplification gain, the repeater may determine the transmit power and/or the amplification gain according to the maximum transmit power and/or the maximum amplification gain, and specific implementations thereof are as described above, which shall not be repeated herein any further. The first parameter may include a first parameter A for determining the first transmit power and/or the first amplification gain and a first parameter B for determining the second transmit power and/or the second amplification gain, the first parameter A and the first parameter B being identical or different, and this disclosure is not limited thereto.

In some embodiments, the second parameter includes an index of the reference signal, and/or a used sequence, and/or a time-frequency resource used for transmitting/receiving the reference signal, and/or transmit power of the reference signal. The reference signal includes a first reference signal and/or a second reference signal and/or a third reference signal, and the repeater may determine the first transmit power and/or the first amplification gain and/or the second transmit power and/or the second amplification gain according to the reference signal configured by the second parameter. That is, in 1403, the repeater may forward the first forwarding signal according to the first transmit power and/or the first amplification gain determined by the reference signal configured by the second parameter, and/or forward the second forwarding signal according to the second transmit power and/or the second amplification gain determined by the reference signal configured by the second parameter, a specific implementation of which being as described above, which shall not be repeated herein any further. The second parameter may include a second parameter A for determining the first transmit power and/or the first amplification gain and a second parameter B for determining the second transmit power and/or the second amplification gain, the second parameter A and the second parameter B being identical or different, and this disclosure is not limited thereto.

In some embodiments, the repeater may determine the transmit power and/or the amplification gain according to the bandwidth and/or the subcarrier spacing determined by the third parameter. In 1403, the repeater may forward the first forwarding signal according to the first transmit power and/or the first amplification gain determined according to the bandwidth and/or the subcarrier spacing determined by the third parameter and/or forward the second forwarding signal according to the second transmit power and/or the second amplification gain determined according to the bandwidth and/or the subcarrier spacing determined by the third parameter, a specific implementation of which being as described above, which shall not be repeated herein any further. The third parameter may include a third parameter A for determining the first transmit power and/or the first amplification gain and a third parameter B for determining the second transmit power and/or the second amplification gain, the third parameter A and the third parameter B being identical or different, and this disclosure is not limited thereto.

In some embodiments, the fourth parameter includes index/indices of the third transmission signal and/or the fourth transmission signal, and/or a used sequence, and/or a time-frequency resource for transmitting/receiving the third transmission signal and/or the fourth transmission signal, and/or transmit power of the third transmission signal and/or the fourth transmission signal. The repeater may transmit the third transmission signal and/or the fourth transmission signal configured by the fourth parameter to the first device and/or second device, and in 1403, the repeater may forward the first forwarding signal and/or the second forwarding signal according to the determined transmit power and/or amplification gain. For example, the repeater may transmit the third transmission signal and/or the fourth transmission signal according to the transmit power configured by the fourth parameter. Reference may be made to 1301 and 1303 for other implementations, which shall not be repeated herein any further. Wherein, the third transmission signal is transmitted to the second device, and the fourth transmission signal is transmitted to the first device.

In some embodiments, there exists connection between the repeater and the third device, and there exists or there exists no connection between the repeater and the second device, and there exists or there exists no connection between the first device and the second device. Wherein, there existing connection refers to, for example, that communication or information exchange may be performed between devices, for example, user plane data may be transmitted/received (including demodulation/decoding), and/or data that may only be transmitted in an RRC connected state may be transmitted/received (including demodulation/decoding), and/or data scrambled by a device-specific identifier (such as an RNTI) may be transmitted/received (including demodulation/decoding), between devices.

In some embodiments, the third device is a network device.

In some embodiments, if there exists connection between two devices, one device may be referred to as a serving device, or a serving cell (if the one device is a network device), or a parent node, of the other device. For example, if there exists connection between the repeater and the third device, the third device is a serving device, or a serving cell, or a parent node, of the repeater. For example, if the repeater is accessed to the third device (or a cell served by the third device) in a random access procedure and establishes connection with the third device, the cell is a serving cell of the repeater. For another example, when the first device and the second device are a network device and a terminal equipment respectively, if there exists connection between the first device and the second device, the network device is a serving device (or a serving cell) of the terminal equipment; however, the embodiments of this disclosure is not limited thereto.

In some embodiments, the third device is the first device, that is, the repeater not only exists connection with the third device, but also forwards signals transmitted by the device and/or signals transmitted by other devices to the third device. For example, the repeater serves for one or more first devices (in terms of amplifying signals), one or more first devices are also the third devices.

In some embodiments, the third device is not the first device, that is, the repeater exists connection with the third device but does not forward signals transmitted by the third device and does not forward signals transmitted by other devices to the third device.

FIG. 15 is a schematic diagram of the signal transmitting method of the embodiment of this disclosure. As shown in FIG. 15, the method includes:
1501: the repeater transmits second information to the third device, the second information being used to indicate the maximum transmit power and/or the maximum amplification gain of the repeater, and/or the transmit power and/or the amplification gain of the repeater, and/or transmit power and/or an amplification gain of the third transmission signal and/or the fourth transmission signal, and/or an operational bandwidth of the repeater;
1502: the repeater receives the first forwarding signal and/or the second forwarding signal; and
1503: the repeater transmits the first forwarding signal at the first transmit power and/or the first amplification gain, and/or transmits the second forwarding signal at the second transmit power and/or the second amplification gain.

In some embodiments, the maximum transmit power and/or the maximum amplification gain of the repeater includes first maximum transmit power and/or a first maximum amplification gain, and/or second maximum transmit power and/or a second maximum amplification gain, and the transmit power and/or the amplification gain of the repeater includes the first transmit power and/or the first amplification gain, and/or the second transmit power and/or the second amplification gain; however, this disclosure is not limited thereto.

In some embodiments, a difference from the method in FIG. 14 lies in that the repeater does not need to determine the transmit power and/or the amplification gain according to the first information configured by the third device, instead, it autonomously generates the above second information, determines the transmit power and/or the amplification gains of the first/second/third/fourth transmission signals accordingly, and notifies the third device of the second information. Implementation of determining the transmit power and/or the amplification gains according to the parameters in the second information is as described above, and shall not be repeated herein any further.

In some embodiments, the operating bandwidth of the repeater may also be referred to as an operating frequency range, including an operating frequency band, a carrier, and a passband, etc. The operating bandwidth of the repeater includes, for example, a first operating bandwidth for receiving, amplifying and transmitting signals, and/or a second operating bandwidth for receiving signals transmitted to the repeater and/or for transmitting signals of the repeater. In some cases, the first operating bandwidth is also used to receive signals transmitted to the repeater and/or to transmit signals of the repeater. Frequency positions and/or bandwidth sizes to which the first operating bandwidth and the second operating bandwidth correspond are identical or different. The first operating bandwidth and the second operating bandwidth are crossed or overlapped or not in a frequency domain.

In some embodiments, the repeater may operate in one or more frequency bands. From the perspective of amplifying signals, the repeater may receive, amplify and transmit signals within one or more frequency bands. From the perspective of receiving signals transmitted to the repeater and/or transmitting signals to the repeater, the repeater may receive and/or transmit signals within one or more frequency bands.

For example, the first operating bandwidth may include one or more frequency ranges of identical frequency bands or different frequency bands (the frequency ranges are, for example, referred to as pass bands, and carriers, etc.). For example, the number of the first operating bandwidth is one or more. A pass band may include one or more consecutive channels (such as being referred to as nominal channels) or carriers.

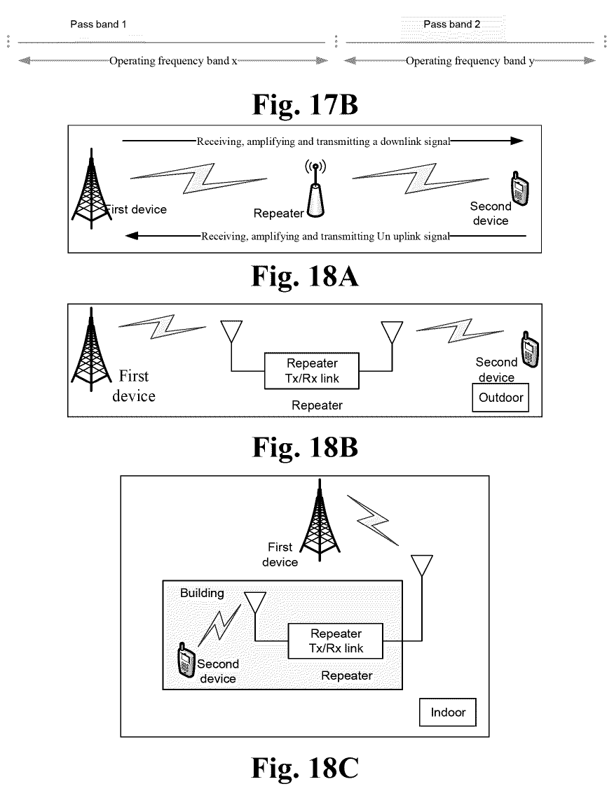

For the first operating bandwidth used for downlink, in a case where multiple pass bands are included, two of them may be in identical or different frequency bands. FIGS. 17A and 17B are schematic diagrams of the operating bandwidth. As shown in FIG. 17A, two pass bands are in identical frequency bands, and as shown in FIG. 17B, two pass bands are in different frequency bands.

It should be noted that an order of execution of 1301 and 1302, 1401 and 1402, 1501 and 1502 is not limited. The methods in FIGS. 13-15 may be executed separately or in a combined manner, and the implementations in 1303, 1403 and 1503 may be executed separately or in combination with the above aspects, and this disclosure is not limited thereto.

In addition, in the methods shown in FIGS. 13-15, 1301, 1401 and 1501 may only be executed, or in other words, in the methods shown in FIGS. 13-15, transmission of the third transmission signal, the fourth transmission signal, the first information and/or the second information may be independent of the first forwarding signal and the second forwarding signal. In other words, the transmit power and/or the amplification gain(s) of the first forwarding signal and/or the second forwarding signal may be determined without taking the third transmission signal, the fourth transmission signal, the first information and/or the second information into account.

In the embodiments of this disclosure, there is also provided a signal receiving method, the method including (not shown):
the repeater receives a reference signal.
the reference signal being used for performing measurement by the repeater and/or for determining a pathloss and/or a coupling loss by the repeater.

In some embodiments, the method may further include:
the repeater determines the first transmit power and/or the first amplification gain for transmitting the first forwarding signal and/or the second transmit power and/or the second amplification gain for transmitting the second forwarding signal according to the reference signal.

In some embodiments, the determining the first transmit power and/or the first amplification gain for transmitting the first forwarding signal and/or the second transmit power and/or second amplification gain for transmitting the second forwarding signal by the repeater according to the reference signal includes:
the repeater determines a pathloss and/or a coupling loss according to the reference signal; and
the repeater determines the first transmit power and/or the first amplification gain for transmitting the first forwarding signal and/or the second transmit power and/or the second amplification gain for transmitting the second forwarding signal according to the pathloss and/or the coupling loss.

Meanings of the reference signal, the first forwarding signal and the second forwarding signal shall not be repeated herein any further.

In some embodiments, the reference signal used to determine the first transmit power and/or the first amplification gain is identical to or different from the reference signal used to determine the second transmit power and/or the second amplification gain, wherein that the reference signals are different includes that transmitter ends of the reference signals are different, and/or types of the reference signals are different, and/or indices of the reference signals are different.

In some embodiments, the repeater determines the first transmit power and/or first amplification gain according to the first reference signal, and/or, the repeater determines the second transmit power and/or the second amplification gain according to the second reference signal.

FIGS. 18A-18C are schematic diagrams of application scenarios of the repeater of the embodiment of this disclosure (assuming that the first device and the second device are respectively a network device and a terminal equipment). As shown in FIG. 18A, the repeater may receive, amplify and transmit downlink signals and/or receive, amplify and transmit uplink signals, as shown in FIG. 18B, the repeater may forward signals in an outdoor scenario, and as shown in FIG. 18C, the repeater may forward signals in an indoor scenario.

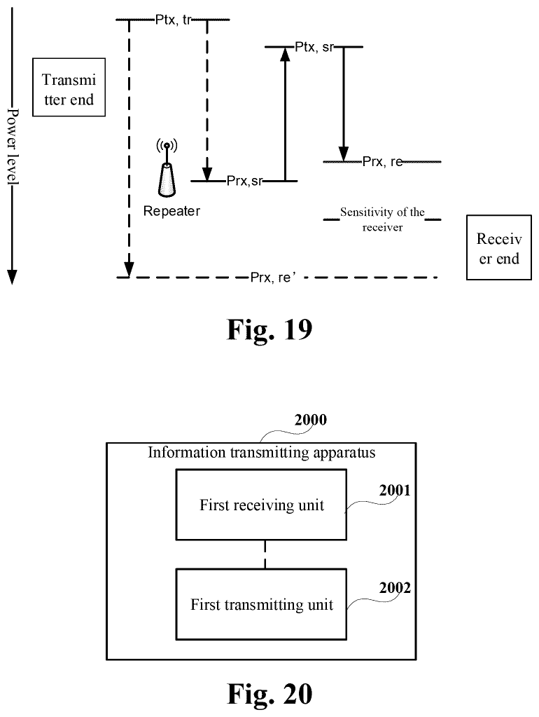

FIG. 19 is a schematic diagram of a change of power of an amplified signal of the repeater shown in the embodiment of this disclosure. As shown in FIG. 19, the dotted lines may represent power of a signal transmitted by the transmitter end directly to a receiver end. If the power is lower than a sensitivity of a receiver, it will cause the receiver end to be unable to successfully receive the signal (or information carried by the signal), while power (solid lines) amplified by the repeater device and reaches the receiver end is higher than the sensitivity of the receiver, and the receiver end may successfully receive the signal. However, the embodiments of this disclosure is not limited thereto such an assumption, and the power of the solid lines and the dotted lines reaching the receiver end may possibly be higher or lower than the sensitivity of the receiver. On the other hand, the power reaching the receiver end indicated by the solid lines and dashed lines may be approximate or identical. For the receiver end, information carried by a signal of a path may be demodulated/decoded based on the signal, or the information carried by the signal may be demodulated/decoded based on a combined signal including signals of different paths.

The steps or processes related to this disclosure are only described above; however, this disclosure is not limited thereto. The method of the embodiments of this disclosure may also include other steps or processes, and reference may be made to relevant techniques for specific contents of these steps or processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, by controlling power of the repeater in forwarding signals, signal coverage may be enhanced and interference to other surrounding devices may be reduced, thereby improving a transmission efficiency of the whole network.

### Embodiments of a Second Aspect

The embodiments of this disclosure provides a signal receiving method, which shall be described from a side of a second device, with contents identical to those in the embodiments of the first aspect being not going to be described herein any further. The method includes (not shown): the second device receives, a third transmission signal transmitted by a repeater, the third transmit signal including a reference signal. For example, the third transmission signal is used for the second device to determine a pathloss and/or a coupling loss, and/or for the second device to perform measurement.

The method may further include: the second device determines a measurement result based on the third transmission signal, and reporting the measurement result to the repeater, and/or the first device, and/or the third device, by.

The embodiments of this disclosure provides a signal receiving method, which shall be described from a side of a first device, with contents identical to those in the embodiments of the first aspect being not going to be described herein any further. The method includes (not shown): the first device receives, a fourth transmission signal transmitted by a repeater, the fourth transmit signal including a reference signal. For example, the fourth transmission signal is used for the first device to determine a pathloss and/or a coupling loss, and/or for the first device to perform measurement.

The method may further include: the first device determines a measurement result based on the fourth transmission signal, and reports the measurement result to the repeater, and/or the second device, and/or the third device.

The embodiments of this disclosure provides a signal transmitting method, which shall be described from a side of a third device, with contents identical to those in the embodiments of the first aspect being not going to be described herein any further. The method includes (not shown): the third device transmits first information to a repeater, the first information being used to indicate a first parameter used by the repeater to determine transmit power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal.

The embodiments of this disclosure provides a signal receiving method, which shall be described from a side of a third device, with contents identical to those in the embodiments of the first aspect being not going to be described herein any further. The method includes (not shown): the third device receives, second information transmitted by a repeater, the second information being used to indicate maximum transmit power and/or a maximum amplification gain of the repeater, and/or transmit power and/or an amplification gain of the repeater, and/or transmit power and/or amplification gain(s) of a third transmission signal and/or a fourth transmission signal, and/or an operating bandwidth of the repeater.

Reference may be made to the methods in FIGS. 13-15 for the above methods for receiving information and methods for transmitting information, and repeated parts shall not be described herein any further.

In order to better illustrate the above methods for receiving information and methods for transmitting information, methods for exchanging signals between the first device, the repeater and the second device shall be described below with reference to FIGS. 24-29 (by taking that the first device is a network device and the second device is a terminal equipment as an example).

FIG. 24 shows that the repeater determines the first transmit power and/or the first amplification gain and/or the second transmit power and/or the second amplification gain according to the first reference signal. The first reference signal may also be the third reception signal described above, and the repeater needs to perform measurement according to the first reference signal. The repeater may transmit or not transmit the third reception signal (also referred to as a fourth transmission signal) to the second device. When the third device is the first device, the configuration information and indication information may be deemed as being included in the first information described above. Following detailed description shall be give with reference to FIG. 24. As shown in FIG. 24, the method includes:
2401: the first device transmits configuration information of the first reference signal to the repeater;
2402: the repeater forwards or does not forward the configuration information of the first reference signal to the second device;
2403: the first device transmits the first reference signal to the repeater;
2404: the repeater forwards or does not forward the first reference signal to the second device;
2405: the repeater performs measurement according to the first reference signal;
2406: the repeater transmits or does not transmit a measurement result based on the first reference signal to the first device;
2407: the first device transmits or does not transmit indication information indicating the amplification power and/or the amplification gain of the repeater to the repeater;
2408: the repeater determines the first transmit power and/or the first amplification gain and/or the second amplification power and/or the second amplification gain;
2409: the first device transmits the first forwarding signal to the repeater;
2410: the repeater transmits the first forwarding signal at the first transmit power and/or the first amplification gain to the second device;
2411: the second device transmits a second forwarding signal to the repeater; and
2412: the repeater transmits the second forwarding signal at the second transmit power and/or the second amplification gain to the second device.

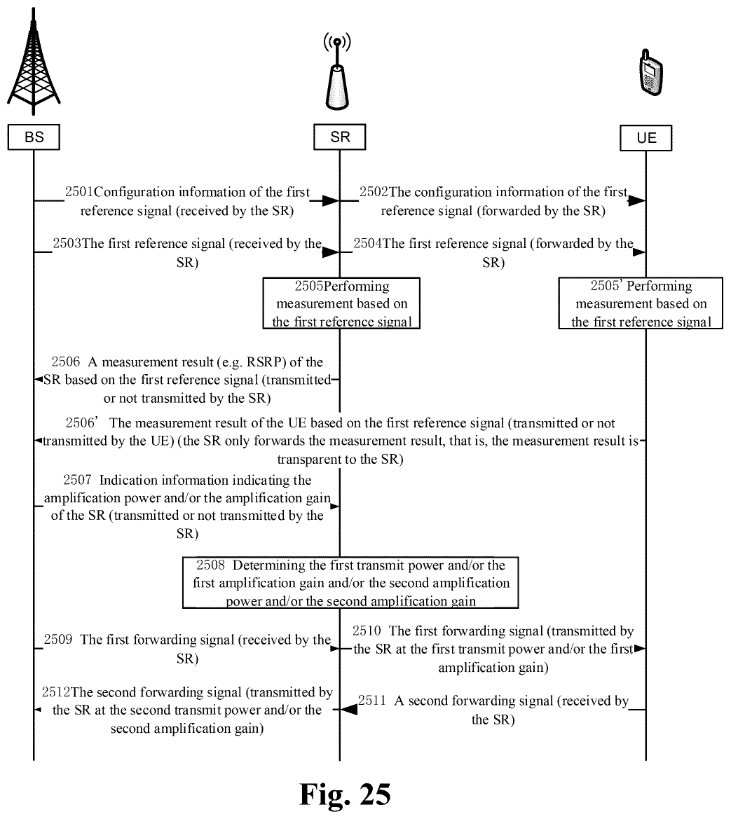

As shown in FIG. 25, a difference from FIG. 24 is that the repeater forwards the configuration information of the first reference signal and the first reference signal to the second device, and both the repeater and the second device receive (demodulate/decode) the configuration information, and in addition to that the repeater performs measurement based on the first reference signal, the second device also performs measurement based on the first reference signal. In addition, the second device transmits or does not transmit the measurement result to the first device, and as shown in FIG. 25, the method includes:
2501: the first device transmits configuration information of the first reference signal to the repeater;
2502: the repeater forwards the configuration information of the first reference signal to the second device;
2503: the first device transmits the first reference signal to the repeater;
2504: the repeater forwards the first reference signal to the second device;
2505: the repeater performs measurement based on the first reference signal;
2505′: the second device performs measurement based on the first reference signal;
2506: the repeater transmits or does not transmit a measurement result based on the first reference signal to the first device;
2506′: the second device transmits or does not transmit the measurement result based on the first reference signal to the first device, wherein the repeater only forwards the measurement result, that is, the measurement result is transparent to an SR;
2507: the first device transmits or does not transmit indication information indicating the amplification power and/or the amplification gain of the repeater to the repeater;
2508: the repeater determines the first transmit power and/or the first amplification gain and/or the second amplification power and/or the second amplification gain;
2509: the first device transmits the first forwarding signal to the repeater;
2510: the repeater transmits the first forwarding signal at the first transmit power and/or the first amplification gain to the second device;
2511: the second device transmits a second forwarding signal to the repeater; and
2512: the repeater transmits the second forwarding signal at the second transmit power and/or the second amplification gain to the second device.

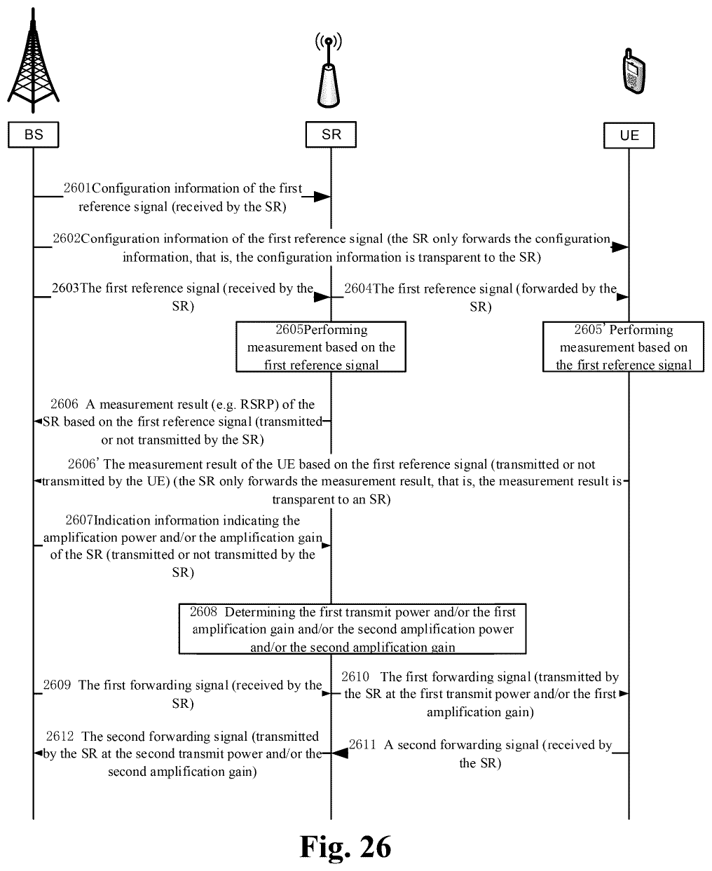

As shown in FIG. 26, a difference from FIG. 25 is that the repeater does not need to demodulate/decode the configuration information of the first reference signal, and forwards the configuration information only to the second device, that is, the configuration information is transparent to the repeater. As shown in FIG. 26, the method includes:
2601: the first device transmits configuration information of the first reference signal to the repeater;
2602: the first device transmits (forwarding by the repeater) the configuration information of the first reference signal to the second device;
2603: the first device transmits the first reference signal to the repeater;
2604: the repeater forwards the first reference signal to the second device;
2605: the repeater performs measurement based on the first reference signal;
2605′: the second device performs measurement based on the first reference signal;
2606: the repeater transmits or does not transmit a measurement result based on the first reference signal to the first device;
2606′: the second device transmits or does not transmit the measurement result based on the first reference signal to the first device, wherein the repeater only forwards the measurement result, that is, the measurement result is transparent to an SR;
2607: the first device transmits or does not transmit indication information indicating the amplification power and/or the amplification gain of the repeater to the repeater;
2608: the repeater determines the first transmit power and/or the first amplification gain and/or the second amplification power and/or the second amplification gain;
2609: the first device transmits the first forwarding signal to the repeater;
2610: the repeater transmits the first forwarding signal at the first transmit power and/or the first amplification gain to the second device;
2611: the second device transmits a second forwarding signal to the repeater; and
2612: the repeater transmits the second forwarding signal at the second transmit power and/or the second amplification gain to the second device.

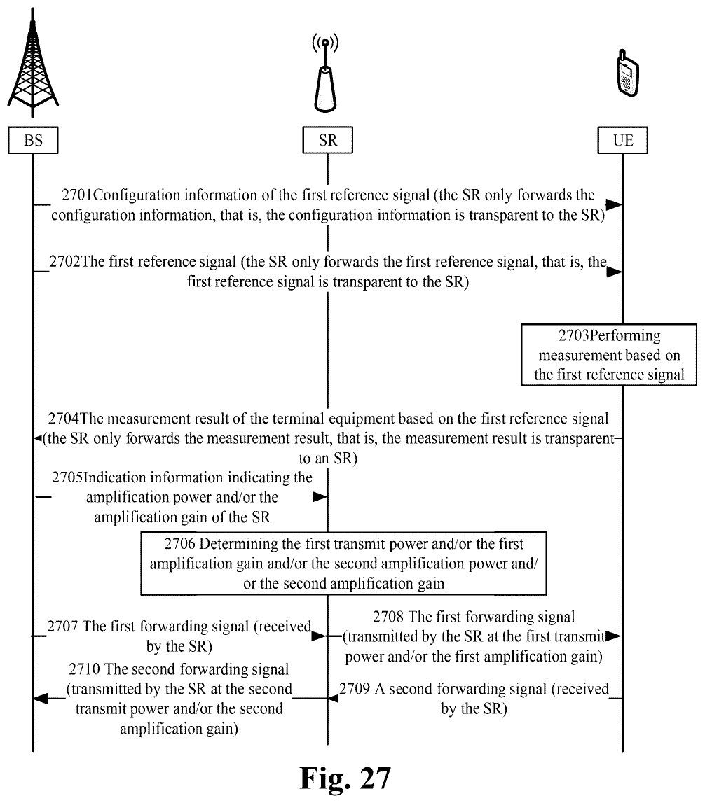

As shown in FIG. 27, a difference from the methods in FIGS. 24-26 is that the repeater forwards the first reference signal only and does not need to measure the first reference signal, nor does it need to report the measurement result. As shown in FIG. 27, the method includes:
2701: the first device transmits (forwarding by the repeater) configuration information of the first reference signal to the second device;
2702: the first device transmits (forwarding by the repeater) the first reference signal to the second device;
2703: the second device performs measurement based on the first reference signal;
2704: the second device transmits the measurement result based on the first reference signal to the first device, wherein the repeater only forwards the measurement result, that is, the measurement result is transparent to an SR;
2705: the first device transmits indication information indicating the amplification power and/or the amplification gain of the repeater to the repeater;
2706: the repeater determines the first transmit power and/or the first amplification gain and/or the second amplification power and/or the second amplification gain;
2707: the first device transmits the first forwarding signal to the repeater;
2708: the repeater transmits the first forwarding signal at the first transmit power and/or the first amplification gain to the second device;
2709: the second device transmits a second forwarding signal to the repeater; and
2710: the repeater transmits the second forwarding signal at the second transmit power and/or the second amplification gain to the second device.

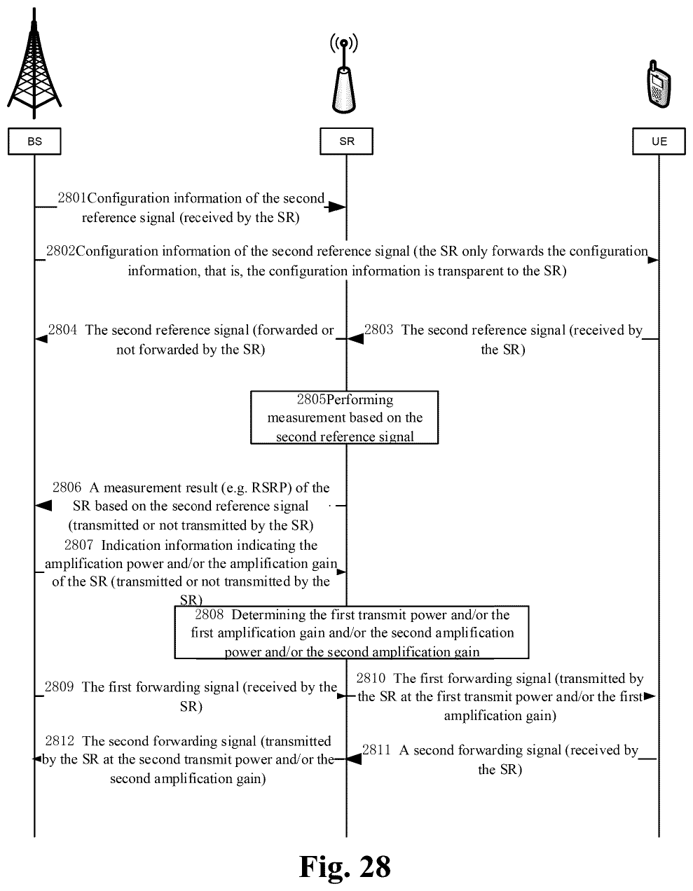

A method in FIG. 28 differs from the methods in FIGS. 24-26 in that the repeater receives a second reference signal and performs measurement based on the second reference signal, and the repeater does not need to demodulate/decode configuration information of the second reference signal, but forwards the configuration information only to the second device, that is, the configuration information is transparent to the repeater. As shown in FIG. 28, the method includes:
2801: the first device transmits configuration information of the second reference signal to the repeater;
2802: the first device transmits (forwarding by the repeater) the configuration information of the second reference signal to the second device;
2803: the second device transmits the second reference signal to the repeater;
2804: the repeater forwards or does not forward the second reference signal to the first device;
2805: the repeater performs measurement based on the second reference signal by;
2806: the repeater transmits or does not transmit a measurement result based on the second reference signal to the first device;
2807: the first device transmits or does not transmit indication information indicating the amplification power and/or the amplification gain of the repeater (such as indicating based on the measurement result; however, it is not limited thereto) to the repeater;
2808: the repeater determines the first transmit power and/or the first amplification gain and/or the second amplification power and/or the second amplification gain;
2809: the first device transmits the first forwarding signal to the repeater;
2810: the repeater transmits the first forwarding signal at the first transmit power and/or the first amplification gain to the second device;
2811: the second device transmits a second forwarding signal to the repeater; and
2812: the repeater transmits the second forwarding signal at the second transmit power and/or the second amplification gain to the second device.

In addition, the method may further include: the first device performs measurement based on the second reference signal, or forwards the second reference signal only by the repeater without needing to perform measurement based on the second reference signal and without needing to report the measurement result, which shall not be enumerated herein any further.

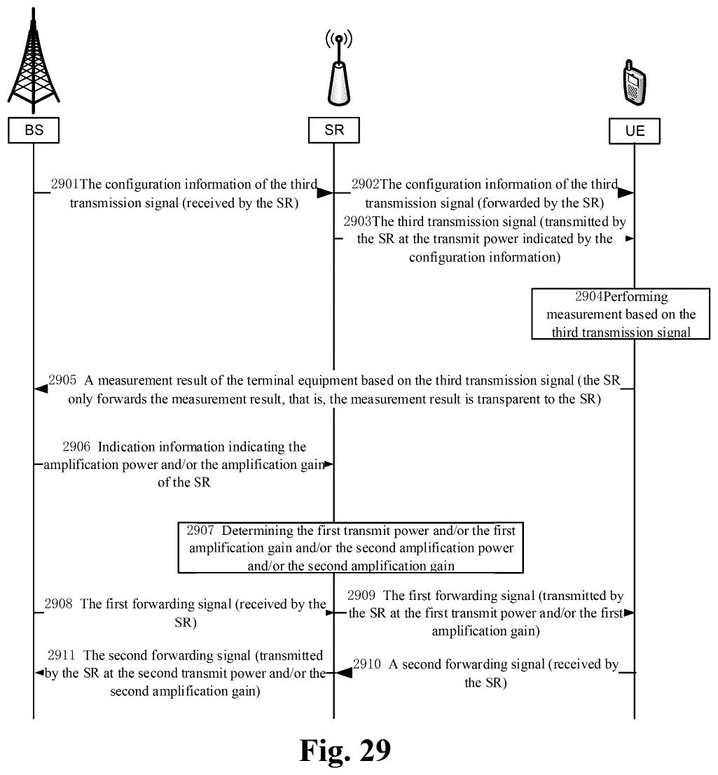

As shown in FIG. 29, similar to the method in FIG. 13, the repeater transmits a third transmission signal to the second device, the third transmission signal including a reference signal, and the second device may perform measurement based on the third transmission signal and report the measurement result, wherein the repeater may receive configuration information of the third transmission signal and transmit the third transmission signal based on transmit power indicated by the configuration information. As shown in FIG. 29, the method includes:
2901: the first device transmits the configuration information of the third transmission signal to the repeater;
2902: the repeater transmits the configuration information of the third transmission signal to the second device;
2903: the repeater transmits the third transmission signal to the second device (at the transmit power indicated by the configuration information);
2904: the second device performs measurement based on the third transmission signal;
2905: the second device transmits or does not transmit a measurement result based on the third transmission signal to the first device, wherein the repeater forwards the measurement result only, that is, the measurement result is transparent to the repeater;
2906: the first device transmits indication information indicating the amplification power and/or the amplification gain of the repeater (such as indicating based on the measurement result; however, it is not limited thereto) to the repeater;
2907: the repeater determines the first transmit power and/or the first amplification gain and/or the second amplification power and/or the second amplification gain;
2908: the first device transmits the first forwarding signal to the repeater;
2909: the repeater transmits the first forwarding signal at the first transmit power and/or the first amplification gain to the second device;
2910: the second device transmits a second forwarding signal to the repeater; and
2911: the repeater transmits the second forwarding signal at the second transmit power and/or the second amplification gain to the second device.

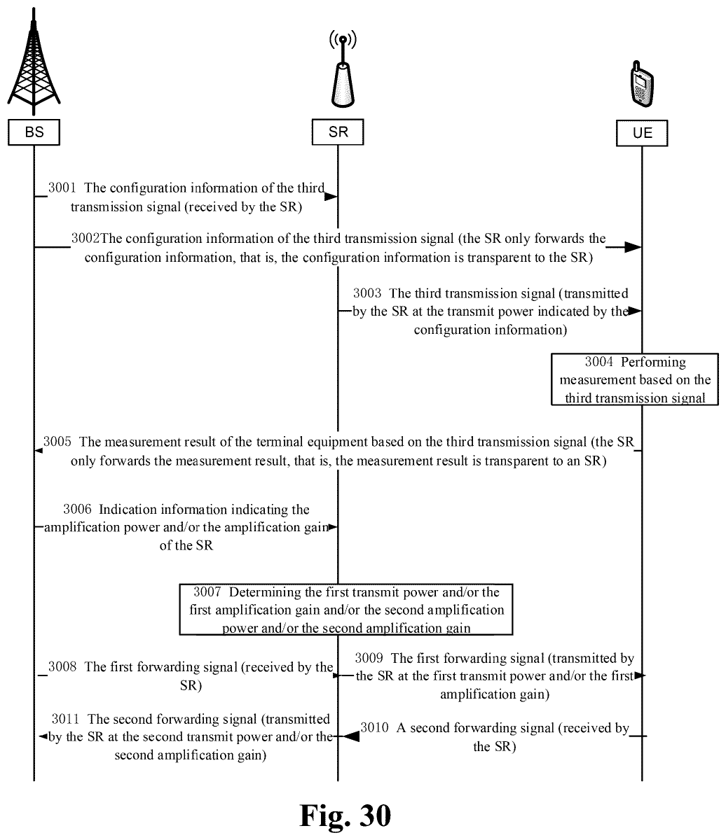

As shown in FIG. 30, a difference from FIG. 29 is that the first device also transmits the configuration information of the third transmission signal to the second device, wherein the repeater forwards only and does not need to demodulate/decode, etc., that is, the configuration information is transparent to the repeater.
3001: the first device transmits the configuration information of the third transmission signal to the repeater;
3002: the first device transmits the configuration information of the third transmission signal to the second device, wherein the repeater forwards the configuration information only, that is, the configuration information is transparent to the repeater;
3003: the repeater transmits the third transmission signal to the second device (at the transmit power indicated by the configuration information);
3004: the second device performs measurement based on the third transmission signal;
3005: the second device transmits or does not transmit a measurement result based on the third transmission signal to the first device, wherein the repeater forwards the measurement result only, that is, the measurement result is transparent to the repeater;
3006: the first device transmits indication information indicating the amplification power and/or the amplification gain of the repeater (such as indicating based on the measurement result; however, it is not limited thereto) to the repeater;
3007: the repeater determines the first transmit power and/or the first amplification gain and/or the second amplification power and/or the second amplification gain;
3008: the first device transmits the first forwarding signal to the repeater;
3009: the repeater transmits the first forwarding signal at the first transmit power and/or the first amplification gain to the second device;
3010: the second device transmits a second forwarding signal to the repeater; and
3011: the repeater transmits the second forwarding signal at the second transmit power and/or the second amplification gain to the second device.

In 2408, 2508, 2608, 2706, 2808, 2907 and 3007, the repeater may determine the first transmit power and/or the first amplification gain and/or the second amplification power and/or the second amplification gain according to the first/second reference signal(s) and/or such other factors as the indication information, and reference may be made to the embodiments of the first aspect for details, which shall not be repeated herein any further.

The steps or processes related to this disclosure are only described above; however, this disclosure is not limited thereto. The method of the embodiments of this disclosure may also include other steps or processes, and reference may be made to relevant techniques for specific contents of these steps or processes. For example, an order of execution of the steps may be appropriately adjusted, and furthermore, some other operations may be added, or some operations therein may be reduced. And appropriate variants may be made by those skilled in the art according to the above contents, without being limited to what is contained in the above accompanying drawings.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, by exchanging signals and/or information between the repeater and the other devices, the repeater may better control the power, hence, signal coverage may be enhanced and interference to other surrounding devices may be reduced, thereby improving a transmission efficiency of the whole network.

### Embodiments of a Third Aspect

The embodiments of this disclosure provides an information transmitting apparatus, applicable to a repeater. As a principle of the apparatus for solving problems is similar to that of the method in the embodiments of the first aspect, reference may be made to the implementation of the method in the embodiments of the first aspect for implementation of the apparatus, with identical parts being not going to be repeated herein any further.

FIG. 20 is a schematic diagram of the information transmitting apparatus. As shown in FIG. 20, the information transmitting apparatus includes:
a first receiving unit 2001 configured to receive a first forwarding signal and/or a second forwarding signal; and
a first transmitting unit 2002 configured to transmit the first forwarding signal at first transmit power and/or a first amplification gain, and/or transmit the second forwarding signal at second transmit power and/or a second amplification gain.

In some embodiments, the first transmit power and/or the first amplification gain is/are configured via signaling, and/or the second transmit power and/or the second amplification gain is/are configured via signaling.

In some embodiments, the apparatus may further include:
a first determining unit (not shown) configured to determine the first transmit power and/or the first amplification gain used to transmit the first forwarding signal, and/or the second transmit power and/or the second amplification gain used to transmit the second forwarding signal.

In some embodiments, values of the first amplification gain and the second amplification gain are identical or different.

In some embodiments, values of the first transmit power and the second transmit power are identical or different.

In some embodiments, the repeater is configured to receive, amplify and transmit the first forwarding signal and/or the second forwarding signal.

In some embodiments, the first forwarding signal is a downlink signal, and the second forwarding signal is an uplink signal.

In some embodiments, the first forwarding signal is from a first device and is transmitted to a second device, and the second forwarding signal is from the second device and is transmitted to the first device.

In some embodiments, the first device is a network device and the second device is a terminal equipment, or, the first device and the second device are terminal equipment, or, the first device and the second device are network devices.

In some embodiments, the first device is a serving device of the second device, and/or the first device is a parent node of the second device, and/or the first device is a control node of the second device.

In some embodiments, the first determining unit determines the first transmit power and/or the first amplification gain and/or the second transmit power and/or the second amplification gain according to at least one of the following items:
a reference signal,
a bandwidth,
a subcarrier spacing,
a target transmission device;
maximum transmit power;
a maximum transmission gain; and
a pathloss and/or a coupling loss.

In some embodiments, the at least one item used to determine the first transmit power and/or the first amplification gain is identical to or different from the at least one used to determine the second transmit power and/or the second amplification gain. Wherein, at least one item may also be referred to as at least one factor, and the at least one factor used to determine (corresponding to) the first transmit power and/or the first amplification gain is identical to or different from the at least one factor used to determine (corresponding to) the second transmit power and/or the second amplification gain; wherein the at least one factor is different includes that types of the factors are different, numbers of the factors are different, or types and numbers of the factors are identical but configurations of the factors are different or values of the factors are different. Or, that the at least one item is different includes that only the first transmit power and/or the first amplification gain or only the second transmit power and/or the second amplification gain is/are determined according to one of the items, and the first transmit power and/or first amplification gain and the second transmit power and/or the second amplification gain is/are determined according to one of the items, but are configured separately. That the at least one item is identical includes that the first transmit power and/or the first amplification gain and the second transmit power and/or the second amplification gain are all determined according to one of the items, and configuration of the item is shared/common.

In some embodiments, the reference signal is used by the repeater to determine the pathloss and/or the coupling loss, and/or is used by the repeater to perform measurement.

In some embodiments, the reference signal includes a first reference signal transmitted by the first device or a third device and/or a second reference signal transmitted by the second device and/or a third reference signal transmitted by a fourth device.

In some embodiments, the reference signal includes an SSB, and/or an S-SSB, and/or a CSI-RS, and/or an SRS.

In some embodiments, the reference signal used to determine the first transmit power and/or the first amplification gain is identical to or different from the reference signal used to determine the second transmit power and/or the second amplification gain.

In some embodiments, that the reference signals are different includes that transmitter ends of the reference signals are different, and/or types of the reference signals are different, and/or indices of the reference signals are different.

In some embodiments, the bandwidth includes a pass band bandwidth and/or a carrier bandwidth and/or a BWP bandwidth and/or a signal bandwidth, and the subcarrier spacing includes a carrier SCS and/or a BWP SCS and/or a signal SCS.

In some embodiments, the bandwidth and/or the subcarrier spacing used to determine the first transmit power and/or the first amplification gain and the bandwidth and/or the subcarrier spacing used to determine the second transmit power and/or the second amplification gain are identical or different.

In some embodiments, the maximum transmit power and/or the maximum amplification gain and/or the subcarrier spacing is/are preconfigured and/or configured via signaling.

In some embodiments, the maximum transmit power (first maximum transmit power) and/or the maximum amplification gain (first maximum amplification gain) used to determine the first transmit power and/or the first amplification gain is/are identical to or different from the maximum transmit power (second maximum transmit power) and/or the maximum transmission gain (second maximum amplification gain) used to determine the second transmit power and/or the second amplification gain.

In some embodiments, the first determining unit determines the pathloss and/or coupling loss according to the reference signal, and determines the transmit power and/or amplification gain according to the determined pathloss and/or coupling loss.

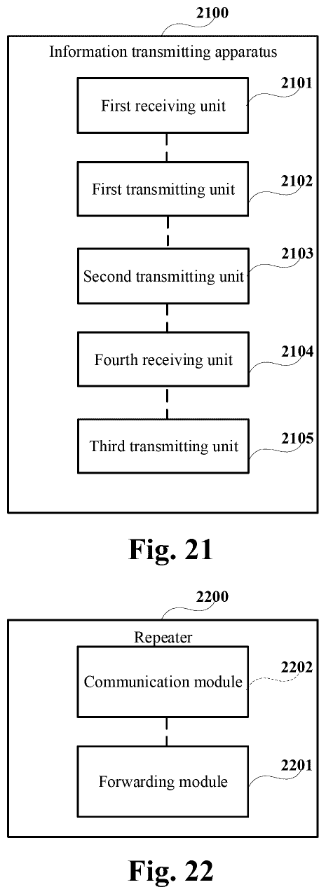

FIG. 21 is a schematic diagram of a structure of the information transmitting apparatus of the embodiment of this disclosure. As shown in FIG. 21, the apparatus includes a first receiving unit 2101 and a first transmitting unit 2102, and reference may be made to the first receiving unit 2001 and the first transmitting unit 2002 for implementations thereof, which shall not be repeated herein any further.

The apparatus may further include:
a second transmitting unit 2103 configured to transmit a third transmission signal, the third transmission signal including a reference signal, and/or
configured to transmit a fourth transmission signal, the fourth transmission signal including a reference signal.

In some embodiments, the apparatus further includes (not shown):
a generating unit configured to generate a third transmission signal or a fourth transmission signal, or,
a second receiving unit configured to receive the third transmission signal generated and transmitted by the first device, and/or,
a third receiving unit configured to receive the fourth transmission signal generated and transmitted by the second device.

In some embodiments, the third transmission signal is used for the second device to determine the pathloss and/or the coupling loss, and/or for the second device to perform measurement, and/or the fourth transmission signal is used for the first device to determine the pathloss and/or the coupling loss, and/or for the first device to perform measurement.

In some embodiments, the apparatus includes (not shown):
a fifth receiving unit configured to receive a measurement result based on the third transmission signal of the second device, and/or receive the measurement result based on the fourth transmission signal of the first device.

In some embodiments, the apparatus includes (not shown):
a second determining unit configured to, based on the measurement result, determine the transmit power and/or the amplification gain of the first forwarding signal transmitted to the second device and/or determine the transmit power and/or the amplification gain of the second forwarding signal transmitted to the first device.

In some embodiments, the apparatus includes:
a fourth receiving unit 2104 configured to receive first information transmitted by a third device, the first information being used to indicate a first parameter used for the repeater to determine transmit power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal.

In some embodiments, the first parameter includes the transmit power and/or the amplification gain of the repeater, or the maximum transmit power and/or the maximum amplification gain of the repeater.

In some embodiments, the second parameter includes an index of the reference signal, and/or a used sequence, and/or a time-frequency resource used to transmit/receive a reference signal, and/or transmit power of the reference signal.

In some embodiments, the fourth parameter includes an index/indices of the third transmission signal and/or the fourth transmission signal, and/or a used sequence, and/or a time-frequency resource used to transmit/receive the third transmission signal and/or the fourth transmission signal, and/or transmit power of the third transmission signal and/or the fourth transmission signal.

In some embodiments, the third transmission signal is used by the second device for determining the pathloss and/or coupling loss, and/or for performing measurement by the second device; and the fourth transmission signal is used by the first device for determining the pathloss and/or coupling loss, and/or for performing measurement by the first device.

In some embodiments, the third device is a serving device/cell of the repeater.

In some embodiments, the third device is a terminal equipment.

In some embodiments, the first information is contained in side control information.

In some embodiments, the apparatus further includes:
a third transmitting unit 2105 configured to transmit second information to the third device, the second information being used to indicate the maximum transmit power and/or the maximum amplification gain of the repeater, and/or the transmit power and/or the amplification gain of the repeater, and/or transmit power and/or an amplification gain of the third transmission signal and/or the fourth transmission signal, and/or an operational bandwidth of the repeater.

In the embodiments of this disclosure, in addition to the first receiving unit 2101 and the first transmitting unit 2102, the apparatus may further includes at least one of a second transmitting unit 2103, a fourth receiving unit 2104 and a third transmitting unit 2105, or, the apparatus may only includes at least one of a second transmitting unit 2103, a fourth receiving unit 2104 and a third transmitting unit 2105, and does not include the first receiving unit 2101 and the first transmitting unit 2102; however, the embodiments of this disclosure is not limited thereto.

The embodiments of this disclosure further provides a signal receiving apparatus, including (not shown):
a receiving unit configured to receive a reference signal, the reference signal being used for the repeater to perform measurement, and/or used for the repeater to determine a pathloss and/or a coupling loss.

In some embodiments, the apparatus may further include:
a determining unit configured to determine the first transmit power and/or first amplification gain for transmitting the first forwarding signal, and/or the second transmit power and/or second amplification gain for transmitting the second forwarding signal, according to the reference signal.

In some embodiments, the determining unit determines the pathloss and/or the coupling loss according to the reference signal, and determines the first transmit power and/or the first amplification gain for transmitting the first forwarding signal and/or the second transmit power and/or second amplification gain for transmitting the second forwarding signal, according to the pathloss and/or the coupling loss.

Meanings of the reference signal, first forwarding signal and second forwarding signal shall not be repeated herein any further.

In some embodiments, the reference signal used to determine the first transmit power and/or the first amplification gain is identical to or different from the reference signal used to determine the second transmit power and/or the second amplification gain, wherein that the reference signals are different includes that transmitter ends of the reference signals are different, and/or types of the reference signals are different, and/or indices of the reference signals are different.

In some embodiments, the determining unit determines the first transmit power and/or the first amplification gain according to the first reference signal, and/or, the determining unit determines the second transmit power and/or the second amplification gain according to the second reference signal.

The embodiments of this disclosure further provides a repeater (not shown), including the above-described information transmitting apparatus, and contents thereof being incorporated herein, with repeated parts being not going to be described herein any further. The repeater may be, for example, a network device or a terminal equipment, or one or some components or assemblies configured in the network device or the terminal equipment, and reference may be made to the embodiments of the first aspect for details.

The embodiments of this disclosure further provides a repeater. FIG. 22 is a schematic diagram of the repeater of the embodiments of this disclosure. As a principle of the repeater for solving problems is similar to that of the method in the embodiments of the first aspect, reference may be made to the implementation of the method in the embodiments of the first aspect for implementation of the repeater, with identical parts being not going to be repeated herein any further.

As shown in FIG. 22, the repeater 2200 of the embodiments of this disclosure includes a forwarding module 2201 and/or a communication module 2202. The forwarding module 2201 is configured to perform forwarding in an RF domain, and communication module 2202 is configured to communicate with a first device and/or a second device.

The forwarding module 2201 receives a first forwarding signal and/or a second forwarding signal, and transmits the first forwarding signal at first transmit power and/or a first amplification gain, and/or transmits the second forwarding signal at second transmit power and/or a second amplification gain.

The communication module 2202 transmits a third transmission signal and/or a fourth transmission signal, and/or transmits second information to a third device and/or receives first information transmitted by the third device. Implementations of the third transmission signal, fourth transmission signal, first information and second information are as described above, which shall not be repeated herein any further.

And/or, the communication module 2202 receives a reference signal, the reference signal being used for performing measurement by the repeater, and/or being used for determining a pathloss and/or a coupling loss by the repeater.

Implementations of the forwarding module 2201 and communication module 2202 are described above, and shall not be described herein any further.

It should be noted that the components or modules related to this disclosure are only described above. However, this disclosure is not limited thereto, and the repeater 2200 of the embodiments of this disclosure may further include other components or modules, and reference may be made to related techniques for particulars of these components or modules.

Furthermore, for the sake of simplicity, connection relationships between the components or modules or signal profiles thereof are only illustrated in FIG. 22. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, by controlling power of the repeater in forwarding signals, signal coverage may be enhanced and interference to other surrounding devices may be reduced, thereby improving a transmission efficiency of the whole network.

### Embodiments of a Fourth Aspect

The embodiments of this disclosure provides an information receiving apparatus, applicable to a second device, with contents identical to those in the embodiments of the second aspect being not going to be described herein any further. The apparatus includes (not shown) a receiving unit configured to receive a third transmission signal transmitted by a repeater, the third transmission signal including a reference signal, and for example, the third transmission signal being used for the second device to determine a pathloss and/or a coupling loss, and/or for the second device to perform measurement.

The apparatus may further include a processing unit configured to determine a measurement result based on the third transmission signal and report the measurement result to the repeater, and/or a first device, and/or a third device, wherein the third transmission signal includes a reference signal.

The embodiments of this disclosure provides an information receiving apparatus, applicable to a first device, with contents identical to those in the embodiments of the second aspect being not going to be described herein any further. The apparatus includes (not shown) a receiving unit configured to receive a fourth transmission signal transmitted by a repeater, the fourth transmission signal including a reference signal, and for example, the fourth transmission signal being used for the first device to determine a pathloss and/or a coupling loss, and/or for the first device to perform measurement.

The apparatus may further include a processing unit configured to determine a measurement result based on the fourth transmission signal and report the measurement result to the repeater, and/or a second device, and/or a third device, wherein the fourth transmission signal includes a reference signal.

The embodiments of this disclosure provides an information transmitting apparatus, applicable to a third device, with contents identical to those in the embodiments of the second aspect being not going to be described herein any further. The apparatus includes (not shown) a transmitting unit configured to transmit first information to a repeater, the first information being used to indicate a first parameter for determining transmit power and/or an amplification gain by the repeater, and/or being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal.

The embodiments of this disclosure provides an information receiving apparatus, applicable to a third device, with contents identical to those in the embodiments of the second aspect being not going to be described herein any further. The apparatus includes (not shown) a receiving unit configured to receive second information transmitted by a repeater, the second information being used to indicate maximum transmit power and/or a maximum amplification gain of the repeater, and/or transmit power and/or an amplification gain of the repeater, and/or transmit power and/or amplification gain(s) of the third transmission signal and/or the fourth transmission signal, and/or an operating bandwidth of the repeater.

Reference may be made to the methods in FIGS. 13-15 for the information receiving apparatus and the information transmitting apparatus, with repeated parts being not going to be described herein any further.

It should be noted that the components or modules related to this disclosure are only described above. However, this disclosure is not limited thereto, and the information receiving apparatus and the information transmitting apparatus of the embodiments of this disclosure may further include other components or modules, and reference may be made to related techniques for particulars of these components or modules.

The above embodiments only provide exemplary explanations for the embodiments of the present application, but the present application is not limited thereto, and appropriate modifications may be made according to the above embodiments. For example, the above embodiments may be used separately, or one or more of the above embodiments may be combined.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, by exchanging signals/information between the repeater and the other devices, the repeater is enabled to better control the power. Hence, signal coverage may be enhanced and interference to other surrounding devices may be reduced, thereby improving a transmission efficiency of the whole network.

### Embodiments of a Fifth Aspect

The embodiments of this disclosure provides a communication system. FIG. 1 is a schematic diagram of the communication system of the embodiments of this disclosure. As shown in FIG. 1, the communication system 100 includes a first device 101, a repeater 102 and a second device 103. For the sake of simplicity, description is given in FIG. 1 by taking one first device, one repeater and one second device only as an example; however, the embodiments of this disclosure is not limited thereto.

In the embodiments of this disclosure, the repeater 102 is configured to execute the signal transmitting method as described in the embodiments of the first aspect, and the first device 101 and the second device 102 are configured to execute the method as described in the embodiments of the second aspect, contents thereof being incorporated herein, and being not going to be repeated herein any further.

In the embodiments of this disclosure, the communication system may further include a third device (not shown) configured to execute the method as described in the embodiments of the second aspect.

The embodiments of this disclosure further provides a repeater.

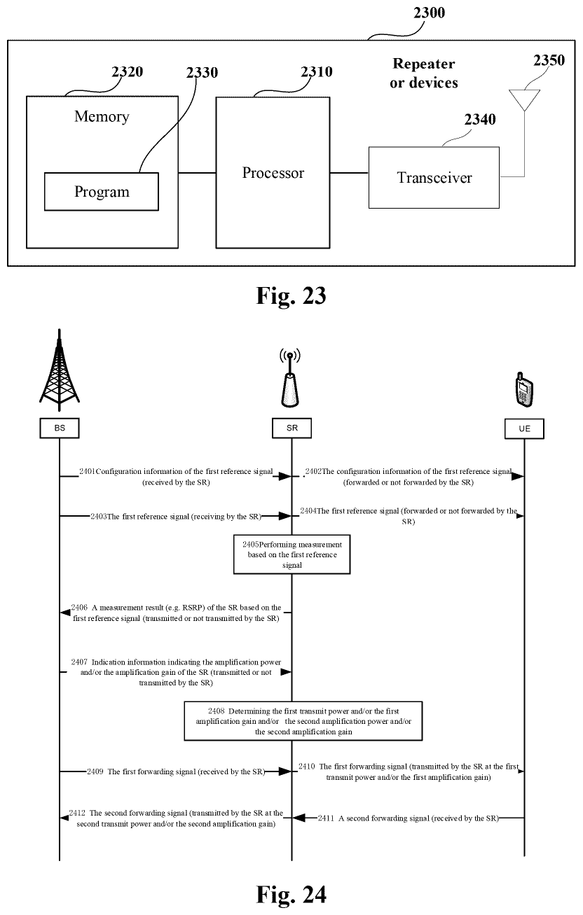

FIG. 23 is a schematic diagram of a structure of the repeater of the embodiment of this disclosure. As shown in FIG. 23, the repeater 2300 may include a processor 2310 (such as a central processing unit (CPU)) and a memory 2320, the memory 2320 being coupled to the processor 2310. The memory 2320 may store various data, and furthermore, it may store a program 2330 for information processing, and executes the program 2330 under control of the processor 2310.

For example, processor 2310 may be configured to execute a program to carry out the signal transmitting method as described in the embodiments of the first aspect. For example, processor 2310 may be configured to perform the following control: receiving a first forwarding signal and/or a second forwarding signal; and transmitting the first forwarding signal at first transmit power and/or a first amplification gain, and/or transmitting the second forwarding signal at second transmit power and/or a second amplification gain.

The processor 2310 may be configured to perform the following control: the reference signal is used for performing measurement by the repeater, and/or for determining a pathloss and/or a coupling loss by the repeater. Furthermore, as shown in FIG. 23, the repeater 2300 may include a transceiver 2340 and an antenna 2350, etc. Wherein, functions of the above components are similar to those in the related art, and shall not be described herein any further. It should be noted that the repeater 2300 does not necessarily include all the parts shown in FIG. 23. Furthermore, the repeater 2300 may include parts not shown in FIG. 23, and the related art may be referred to.

The embodiments of this disclosure further provides a device (which may be a first device, or a second device, or a third device), and reference may be made to FIG. 23 for a structure of the device. For example, the device at least includes a processor 2310 (such as a central processing unit (CPU)) and a memory 2320.

For example, the processor 2310 may be configured to execute a program to carry out the method as described in the embodiments of the second aspect. For example, processor 2310 may be configured to perform the following control: receiving a fourth transmission signal transmitted by a repeater, the fourth transmit signal including a reference signal; for example, the fourth transmission signal is used for the first device to determine a pathloss and/or a coupling loss, and/or for the first device to perform measurement; or
receiving second information transmitted by a repeater, the second information being used to indicate maximum transmit power and/or a maximum amplification gain of the repeater, and/or transmit power and/or an amplification gain of the repeater, and/or transmit power and/or amplification gain(s) of a third transmission signal and/or a fourth transmission signal, and/or an operating bandwidth of the repeater; or
transmitting first information to a repeater, the first information being used to indicate a first parameter used by the repeater to determine transmit power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal; or
receiving a third transmission signal transmitted by a repeater, the third transmission signal including a reference signal, such as being used by the repeater to determine a pathloss and/or a coupling loss, or being used by the second device to perform measurement.

An embodiment of this disclosure provides a computer readable program code, which, when executed in a repeater, will cause a computer to carry out the signal transmitting method as described in the embodiments of the first aspect in the repeater.

An embodiment of this disclosure provides a computer readable medium, including a computer readable program code, which will cause a computer to carry out the signal transmitting method as described in the embodiments of the first aspect in a repeater.

An embodiment of this disclosure provides a computer readable program code, which, when executed in a device, will cause a computer to carry out the method as described in the embodiments of the second aspect in the device.

An embodiment of this disclosure provides a computer readable medium, including a computer readable program code, which will cause a computer to carry out the method as described in the embodiments of the second aspect in a device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. A signal transmitting method, including:
receiving a first forwarding signal and/or a second forwarding signal by a repeater; and
transmitting the first forwarding signal at first transmit power and/or a first amplification gain, and/or transmitting the second forwarding signal at second transmit power and/or a second amplification gain, by the repeater.
1a. The method according to supplement 1, wherein the first transmit power and/or the first amplification gain is/are configured via signaling, and/or, the second transmit power and/or the second amplification gain is/are configured via signaling.
2. The method according to supplement 1, wherein the method further includes:
determining the first transmit power and/or the first amplification gain used to transmit the first forwarding signal, and/or the second transmit power and/or the second amplification gain used to transmit the second forwarding signal, by the repeater.
3. The method according to supplement 1 or 2, wherein values of the first amplification gain and the second amplification gain are identical or different.
4. The method according to supplement 1 or 2, wherein values of the first transmit power and the second transmit power are identical or different.
5. The method according to any one of supplements 1-4, wherein the repeater is configured to receive, amplify and transmit the first forwarding signal and/or the second forwarding signal.
6. The method according to any one of supplements 1-5, wherein the first forwarding signal is a downlink signal, and the second forwarding signal is an uplink signal.
7. The method according to any one of supplements 1-6, wherein the first forwarding signal is from a first device and is transmitted to a second device, and the second forwarding signal is from the second device and is transmitted to the first device.
8. The method according to supplement 7, wherein the first device includes a network device and the second device includes a terminal equipment, or, the first device includes a first terminal equipment and the second device includes a second terminal equipment, or, the first device includes a first network device and the second device includes a second network device.
9. The method according to supplement 7 or 8, wherein the first device is a serving device of the second device, and/or the first device is a parent node of the second device, and/or, the first device is a control node of the second device.
10. The method according to any one of supplements 1-9, wherein the method further includes:
determining the first transmit power and/or the first amplification gain and/or determining the second transmit power and/or the second amplification gain by the repeater according to at least one of the following items:
a reference signal,
a bandwidth,
a subcarrier spacing,
a target transmission device;
maximum transmit power;
a maximum transmission gain; and
a pathloss and/or a coupling loss.
11. The method according to supplement 10, wherein at least one of the items used to determine the first transmit power and/or the first amplification gain is identical to or different from at least one of the parameters used to determine the second transmit power and/or the second amplification gain.
12. The method according to supplement 10 or 11, wherein the reference signal is used to determine the pathloss and/or coupling loss by the repeater, and/or used to perform measurement by the repeater.
13. The method according to any one of supplements 10-12, wherein the reference signal includes a first reference signal transmitted by the first device or a third device and/or a second reference signal transmitted by the second device and/or a third reference signal transmitted by a fourth device.
14. The method according to any one of supplements 10-13, wherein the reference signal includes an SSB, and/or an S-SSB, and/or a CSI-RS, and/or an SRS.
15. The method according to any one of supplements 10-14, wherein the reference signal used to determine the first transmit power and/or the first amplification gain is identical to or different from the reference signal used to determine the second transmit power and/or the second amplification gain.
16. The method according to supplement 15, wherein that the reference signals are different include that transmitting ends of the reference signals are different, and/or types of the reference signals are different and/or indices of the reference signals are different.
17. The method according to supplement 10 or 11, wherein the bandwidth includes a pass band bandwidth and/or a carrier bandwidth and/or a BWP bandwidth and/or a signal bandwidth, and the subcarrier interval includes a carrier SCS and/or a BWP SCS and/or a signal SCS.
18. The method according to supplement 17, wherein the bandwidth and/or the subcarrier spacing used to determine the first transmit power and/or the first amplification gain is/are identical to or different from the bandwidth and/or the subcarrier spacing used to determine the second transmit power and/or the second amplification gain.
19. The method according to supplement 10 or 11, wherein the maximum transmit power and/or the maximum amplification gain and/or subcarrier spacing is/are pre-configured and/or configured via signaling.
20. The method according to supplement 10 or 11 or 19, wherein the maximum transmit power (first maximum transmit power) and/or the maximum amplification gain (first maximum amplification gain) used to determine the first transmit power and/or the first amplification gain is/are identical to or different from the maximum transmit power (second maximum transmit power) and/or the maximum amplification gain (second maximum amplification gain) used to determine the second transmit power and/or the second amplification gain.
21. The method according to supplement 10 or 11, wherein the determining the transmit power and/or the amplification gain by the repeater according to a pathloss and/or a coupling loss includes:
determining the pathloss and/or the coupling loss by the repeater according to the reference signal; and
determining the transmit power and/or the amplification gain according to the determined pathloss and/or the determined coupling loss.
22. The method according to any one of supplements 1-21, wherein the method further includes:
transmitting a third transmission signal by the repeater, the third transmission signal including a reference signal; and/or
transmitting a fourth transmission signal by the repeater, the fourth transmission signal including a reference signal.
22a. The method according to supplement 22, wherein the reference signals included in the third transmission signal and/or the fourth transmission signal respectively include an SSB and/or a CSI-RS and/or an SRS.
23. The method according to supplement 22 or 22a, wherein the method further includes:
generating the third transmission signal or the fourth transmission signal by the repeater, or
receiving, by the repeater, the third transmission signal generated and transmitted by the first device, and/or
receiving, by the repeater, the fourth transmission signal generated and transmitted by the second device.
24. The method according to supplement 22 or 22a or 23, wherein the third transmission signal is used for the second device to determine a pathloss and/or a coupling loss, and/or is used for the second device to perform measurement, and the fourth transmission signal is used for the first device to determine a pathloss and/or a coupling loss, and/or is used for the first device to perform measurement.
25. The method according to any one of supplements 22-24, wherein the method includes:
receiving, by the repeater, a measurement result of the second device according to the third transmission signal, and/or receiving, by the repeater, a measurement result of the first device according to the fourth transmission signal.
26. The method according to supplement 25, wherein the method further includes:
determining a transmit power and/or an amplification gain of the first forwarding signal transmitted to the second device and/or determining a transmit power and/or an amplification gain of the second forwarding signal transmitted to the first device, by the repeater according to the measurement result.
27. The method according to any one of supplements 1-26, wherein the method further includes:
receiving, by the repeater, first information transmitted by the third device, the first information being used to indicate a first parameter used by the repeater to determine transmit power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal.
28. The method according to supplement 27, wherein the first parameter includes transmit power and/or an amplification gain of the repeater, or maximum transmit power and/or a maximum amplification gain of the repeater.
29. The method according to supplement 28, wherein the second parameter includes an index of the reference signal, and/or a used sequence, and/or a time-frequency resource used to transmit/receive the reference signal, and/or transmit power of the reference signal.
30. The method according to supplement 27, wherein the fourth parameter includes an index/indices of the third transmission signal and/or the fourth transmission signal, and/or a used sequence, and/or a time-frequency resource used to transmit/receive the third transmission signal and/or the fourth transmission signal, and/or transmit power of the third transmission signal and/or the fourth transmission signal.
31. The method according to supplement 27, wherein the third transmission signal is used for the second device to determine a pathloss and/or a coupling loss, and/or used for the second device to perform measurement, and the fourth transmission signal is used for the first device to determine a pathloss and/or a coupling loss, and/or used for the first device to perform measurement.
32. The apparatus according to claim 27, wherein the third transmission signal and/or the fourth transmission signal include(s) a reference signal/reference signals.
33. The method according to supplement 27, wherein the third device is a serving device/cell of the repeater
34. The method according to any one of supplements 27-33, wherein the first information is contained in side control information.
35. The method according to any one of supplements 1-35, wherein the method further includes:
transmitting second information by the repeater to the third device, the second information being used to indicate the maximum transmit power and/or maximum amplification gain of the repeater, and/or the transmit power and/or the amplification gain of the repeater, and/or transmit power and/or an amplification gain of a third transmission signal and/or a fourth transmission signal, and/or an operational bandwidth of the repeater.
36. The method according to any one of supplement 1-35, wherein the repeater is a radio frequency repeater.
37. A signal transmitting method, including:
transmitting a third transmission signal by a repeater, the third transmission signal including a reference signal; and/or
transmitting a fourth transmission signal by the repeater, the fourth transmission signal including a reference signal.
38. The method according to supplement 37, wherein the method further includes:
generating the third transmission signal or the fourth transmission signal by the repeater, or
receiving, by the repeater, the third transmission signal generated and transmitted by the first device, and/or
receiving, by the repeater, the fourth transmission signal generated and transmitted by the second device.
39. The method according to supplement 37 or 38, wherein the third transmission signal is used by the second device for determining the pathloss and/or coupling loss, and/or for performing measurement by the second device, and/or, the fourth transmission signal is used by the first device for determining the pathloss and/or coupling loss, and/or for performing measurement by the first device.
40. The method according to any one of supplements 37-39, wherein the method further includes:
receiving a measurement result based on the third transmission signal of the second device by the repeater, and/or receiving a measurement result based on the fourth transmission signal of the first device by the repeater.
41. The method according to supplement 40, wherein the method further includes:
determining, by the repeater based on the measurement result, transmit power and/or an amplification gain of a first forwarding signal transmitted to the second device and/or transmit power and/or an amplification gain of a second forwarding signal transmitted to the first device.
42. A signal transmitting method, including:
receiving, by a second device, a third transmission signal transmitted by a repeater, the third transmit signal including a reference signal.
43. The method according to supplement 42, wherein the method further includes:
determining a measurement result based on the third transmission signal, and transmitting the measurement result to the repeater and/or the first device and/or the third device, by the second device.
44. The method according to supplement 42 or 43, wherein the third transmission signal is used by the second device for determining a pathloss and/or coupling loss, and/or for performing measurement by the second device.
45. An information receiving method, wherein the method includes:
receiving, by a repeater, first information transmitted by a third device, the first information being used to indicate a first parameter used for the repeater to determine transmit power and/or an amplification gain, and/or, being used to indicate a second parameter related to the reference signal, and/or being used to indicate a third parameter related to a bandwidth and/or a subcarrier spacing, and/or being used to indicate a fourth parameter related to a third transmission signal and/or a fourth transmission signal.
46. The method according to supplement 45, wherein the first parameter includes the transmit power and/or the amplification gain of the repeater, or the maximum transmit power and/or the maximum amplification gain of the repeater.
47. The method according to supplement 45, wherein the second parameter includes an index of the reference signal, and/or a used sequence, and/or a time-frequency resource used for transmitting/receiving the reference signal, and/or transmit power of the reference signal.
48. The method according to supplement 45, wherein the fourth parameter includes index/indices of the third transmission signal and/or the fourth transmission signal, and/or a used sequence, and/or a time-frequency resource for transmitting/receiving the third transmission signal and/or the fourth transmission signal, and/or transmit power of the third transmission signal and/or the fourth transmission signal.
49. The method according to supplement 45, wherein the third transmission signal is used for the second device to determine a pathloss and/or a coupling loss, and/or is used for the second device to perform measurement, and the fourth transmission signal is used for the first device to determine a pathloss and/or a coupling loss, and/or is used for the first device to perform measurement.
50. The method according to supplement 45, wherein the third device is a serving device/cell of the repeater.
51. The method according to any one of supplements 45-50, wherein the first information is contained in side control information.
52. An information transmitting method, wherein the method includes:
transmitting first information by a third device to a repeater, the first information being used to indicate first power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal.
53. An information transmitting method, wherein the method includes:
transmitting second information by a repeater to a third device, the second information being used to indicate maximum transmit power and/or a maximum amplification gain of the repeater, and/or transmit power and/or an amplification gain of the repeater, and/or transmit power and/or an amplification gain of a third transmission signal and/or a fourth transmission signal, and/or an operational bandwidth of the repeater.
54. An information receiving method, wherein the method includes:
receiving, by a third device, second information transmitted by a repeater, the second information being used to indicate maximum transmit power and/or a maximum amplification gain of the repeater, and/or being used to indicate transmit power and/or an amplification gain of the repeater, and/or being used to indicate transmit power and/or an amplification gain of a third transmission signal and/or a fourth transmission signal and/or being used to indicate an operational bandwidth of the repeater.
55. A signal transmitting method, including:
receiving, by a first device, a fourth transmit signal transmitted by a repeater, the fourth transmit signal including a reference signal.
56. The method according to supplement 55, wherein the method further includes:

determining a measurement result based on the fourth transmission signal, and reporting the measurement result to the repeater and/or the second device and/or the third device, by the first device.
57. The method according to supplement 55 or 56, wherein the third transmission signal is used by the first device for determining a pathloss and/or coupling loss, and/or for performing measurement by the first device.
58. A signal transmitting method, wherein the method includes:
receiving a reference signal by a repeater,
the reference signal being used for the repeater to perform measurement, and/or used for the repeater to determine a pathloss and/or a coupling loss.
59. The method according to supplement 58, wherein the method includes:
determining by the repeater according to the reference signal, first transmit power and/or a first amplification gain used to transmit a first forwarding signal, and/or second transmit power and/or a second amplification gain used to transmit a second forwarding signal.
60. The method according to supplement 59, wherein that the determining by the repeater according to the reference signal, first transmit power and/or a first amplification gain used to transmit a first forwarding signal, and/or second transmit power and/or a second amplification gain used to transmit a second forwarding signal, includes:
determining the pathloss and/or the coupling loss by the repeater according to the reference signal; and
determining the first transmit power and/or the first amplification gain used to transmit the first forwarding signal, and/or the second transmit power and/or the second amplification gain used to transmit a second forwarding signal, according to the pathloss and/or the coupling loss.
61. The method according to supplement 58 or 59 or 60, wherein the reference signal includes a first reference signal transmitted by the first device or the third device and/or a second reference signal transmitted by the second device.
62. The method according to supplement 61, wherein the first forwarding signal is from the first device and transmitted to the second device, and the second forwarding signal is from the second device and transmitted to the first device.
63. The method according to any one of supplements 58-62, wherein the reference signal includes an SSB, and/or an S-SSB, and/or a CSI-RS, and/or an SRS.
64. The method according to any one of supplements 58-63, wherein the reference signal used to determine the first transmit power and/or the first amplification gain is identical to or different from the reference signal used to determine the second transmit power and/or the second amplification gain.
65. The method according to supplement 64, wherein that the reference signals are different includes that transmitter ends of the reference signals are different, and/or types of the reference signals are different, and/or indices of the reference signals are different.
66. The method according to supplement 61, wherein,
the repeater determines the first transmit power and/or the first amplification gain according to the first reference signal;
and/or,
the repeater determines the second transmit power and/or the second amplification gain according to the second reference signal.
67. A repeater, including a memory and a processor, the memory storing a computer program, wherein the processor is configured to execute the computer program to carry out the signal transmitting method as described in any one of supplements 1-41, 45-51, 53 and 58-66.
68. A second device, including a memory and a processor, the memory storing a computer program, wherein the processor is configured to execute the computer program to carry out the information receiving method as described in any one of supplements 42-44.
69. A third device, including a memory and a processor, the memory storing a computer program, wherein the processor is configured to execute the computer program to carry out the signal transmitting method or a signal receiving method as described in either one of supplements 52 and 54.
70. A first device, including a memory and a processor, the memory storing a computer program, wherein the processor is configured to execute the computer program to carry out a signal receiving method as described in any one of supplements 56-58.

What is claimed is:

1. An information transmitting apparatus, applicable to a repeater, the apparatus comprising:
a receiver configured to receive a first forwarding signal and/or a second forwarding signal; and
a transmitter configured to transmit the first forwarding signal at first transmit power and/or a first amplification gain, and/or transmit the second forwarding signal at second transmit power and/or a second amplification gain.

2. The apparatus according to claim 1, wherein the apparatus further comprising:
processor circuitry configured to determine the first transmit power and/or the first amplification gain used to transmit the first forwarding signal, and/or the second transmit power and/or the second amplification gain used to transmit the second forwarding signal.

3. The apparatus according to claim 1, wherein values of the first amplification gain and the second amplification gain are identical or different.

4. The apparatus according to claim 1, wherein the repeater is configured to receive, amplify and transmit the first forwarding signal and/or the second forwarding signal.

5. The apparatus according to claim 1, wherein the first forwarding signal is a downlink signal, and the second forwarding signal is an uplink signal.

6. The apparatus according to claim 1, wherein the first forwarding signal is from a first device and is transmitted to a second device, and the second forwarding signal is from the second device and is transmitted to the first device.

7. The apparatus according to claim 6, wherein the first device is a network device and the second device is a terminal equipment, or, the first device and the second device are terminal equipment, or, the first device and the second device are network devices.

8. The apparatus according to claim 2, wherein the processor circuitry determines the first transmit power and/or the first amplification gain and/or the second transmit power and/or the second amplification gain according to at least one of the following items:
a reference signal,
a bandwidth,
a subcarrier spacing,
a target transmission device;
maximum transmit power;
a maximum transmission gain; and
a pathloss and/or a coupling loss.

9. The apparatus according to claim 8, wherein the at least one item used to determine the first transmit power and/or the first amplification gain is identical to or different from the at least one used to determine the second transmit power and/or the second amplification gain.

10. The apparatus according to claim 8, wherein the reference signal is used by the repeater to determine the pathloss and/or the coupling loss, and/or is used by the repeater to perform measurement.

11. The apparatus according to claim 8, wherein the reference signal comprises a first reference signal transmitted by the first device and/or a second reference signal transmitted by the second device and/or a third reference signal transmitted by a fourth device.

12. The apparatus according to claim 8, wherein a reference signal used to determine the first transmit power and/or the first amplification gain is identical to or different from a reference signal used to determine the second transmit power and/or the second amplification gain.

13. The apparatus according to claim 1, wherein
the transmitter is further configured to:
transmit a third transmission signal, the third transmission signal comprising a reference signal, and/or
transmit a fourth transmission signal, the fourth transmission signal comprising a reference signal.

14. The apparatus according to claim 1, wherein the receiver is further configured to receive first information transmitted by a third device, the first information being used to indicate a first parameter used for the repeater to determine transmit power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal.

15. The apparatus according to claim 14, wherein the first parameter comprises transmit power and/or an amplification gain of the repeater, or maximum transmit power and/or a maximum amplification gain of the repeater.

16. The apparatus according to claim 15, wherein the second parameter comprises an index of a reference signal, and/or a used sequence, and/or a time-frequency resource used to transmit/receive a reference signal, and/or transmit power of a reference signal.

17. The apparatus according to claim 14, wherein the fourth parameter comprises an index/indices of the third transmission signal and/or the fourth transmission signal, and/or a used sequence, and/or a time-frequency resource used to transmit/receive the third transmission signal and/or the fourth transmission signal, and/or transmit power of the third transmission signal and/or the fourth transmission signal.

18. The apparatus according to claim 1, wherein the receiver is further configured to receive a reference signal, the reference signal being used for the repeater to perform measurement, and/or used for the repeater to determine a pathloss and/or a coupling loss.

19. A signal transceiving apparatus, applicable to a third device, wherein the signal transceiving apparatus comprises:
a transmitter configured to transmit first information to a repeater, the first information being used to indicate a first parameter used for the repeater to determine transmit power and/or an amplification gain, and/or, being used to indicate a second parameter related to a reference signal, and/or being used to indicate a third parameter related to a bandwidth and/or a subcarrier spacing, and/or being used to indicate a fourth parameter related to a third transmission signal and/or a fourth transmission signal; and/or
a receiver configured to receive second information transmitted by the repeater, the second information being used to indicate maximum transmit power and/or a maximum amplification gain of the repeater, and/or being used to indicate transmit power and/or an amplification gain of the repeater, and/or being used to indicate transmit power and/or an amplification gain of a third transmission signal and/or a fourth transmission signal and/or being used to indicate an operational bandwidth of the repeater.

20. An information transmitting apparatus, applicable to a repeater, the apparatus comprising:
a transmitter configured to transmit a third transmission signal, the third transmission signal including a reference signal, and/or transmit a fourth transmission signal, the fourth transmission signal including a reference signal.
